(19) United States
(12) Patent Application Publication
(10) Pub. No.: US 2026/0249735 A1
(43) Pub. Date: Aug. 27, 2026

(54) AGGREGATED VIRTUAL SUBMETERING SYSTEM FOR ELECTRIC VEHICLE SUPPLY EQUIPMENTS

(71) Applicant: PowerFlex Systems, LLC, San Diego, CA (US)

(72) Inventor: Zachary LEE, Pasadena, CA (US)

(21) Appl. No.: 19/548,758

(22) Filed: Feb. 24, 2026

Related U.S. Application Data
(60) Provisional application No. 63/762,579, filed on Feb. 24, 2025.

(51) Int. Cl. B60L 53/67; B60L 53/64; B60L 53/68; G06Q 30/0283

(52) U.S. Cl. CPC B60L 53/67; B60L 53/68; G06Q 30/0283; B60L 53/64

(57) ABSTRACT

Certain aspects provide techniques for managing a plurality of electric vehicle supply equipments (EVSEs). An example method includes obtaining, from the plurality of EVSEs, meter data; assigning a first portion of the meter data to a first submeter grouping associated with at least a first EVSE of the plurality of EVSEs; assigning a second portion of the meter data to a second submeter grouping associated with at least a second EVSE of the plurality of EVSEs; determining, for a defined time period, first aggregate meter data of the first submeter grouping; determining, for the defined time period, second aggregate meter data of the second submeter grouping; formatting the first aggregate meter data in a defined format associated with a service provider; formatting the second aggregate meter data in the defined format associated with the service provider; and transmitting, to the service provider, the formatted first aggregate meter data.

### CROSS-REFERENCE TO RELATED APPLICATION

This application claims the benefit of and priority to U.S. Provisional Patent Application No. 63/762,579, filed on Feb. 24, 2025, the entire contents of which are hereby incorporated by reference.

### INTRODUCTION

Electric vehicle (EV) charging infrastructure is a rapidly evolving field given the popularity of EVs. EV charging stations such as electric vehicle supply equipments (EVSEs) often rely on backend systems (e.g., local and/or cloud-based backend systems) to manage charging sessions. For example, when an EV connects to an EVSE, the EVSE sends a status update to a backend system, which then initiates and manages a charging session. The backend system maintains databases of active charging sessions across multiple sites and EVSEs. As the EV charging infrastructure evolves, an increasing number and/or type of energy assets that support these sites and EVSEs may lead to an increased level of complexity in how such energy assets are managed and controlled. The increased level of complexity in the management and control of the energy assets may be associated with various types of technical challenges. Accordingly, there exists a need for improvements in EV charging infrastructure to overcome these technical challenges. As the EV charging infrastructure continues to expand, such technical challenges are expected to affect more users.

### SUMMARY

Certain aspects provide a method for managing a plurality of electric vehicle supply equipments (EVSEs). The method includes obtaining, from the plurality of EVSEs, meter data; assigning a first portion of the meter data to a first submeter grouping associated with at least a first EVSE of the plurality of EVSEs; assigning a second portion of the meter data to a second submeter grouping associated with at least a second EVSE of the plurality of EVSEs; determining, for a defined time period, first aggregate meter data of the first submeter grouping; determining, for the defined time period, second aggregate meter data of the second submeter grouping; formatting the first aggregate meter data in a defined format associated with a service provider; formatting the second aggregate meter data in the defined format associated with the service provider; and transmitting, to the service provider, the formatted first aggregate meter data and the formatted second aggregate meter data.

Other aspects of the present disclosure provide one or more processing systems configured to perform the aforementioned method as well as those described herein; one or more non-transitory, computer-readable mediums comprising instructions that, when executed by one or more processors of one or more processing systems, cause the one or more processing systems to perform the aforementioned method as well as those described herein; a computer program product embodied on a computer readable storage medium comprising code for performing the aforementioned method as well as those described herein; and a processing system comprising means for performing the aforementioned method as well as those described herein.

The following description and the related drawings set forth in detail certain illustrative features of one or more aspects.

### DESCRIPTION OF THE DRAWINGS

The aspects set forth in the drawings are illustrative and exemplary in nature and not intended to limit the disclosure. The following detailed description of the illustrative aspects can be understood when read in conjunction with the following drawings, where like structure is indicated with like reference numerals and in which:

FIG. 1 depicts a computing environment for managing a plurality of electric vehicle supply equipments (EVSEs), according to aspects provided herein;

FIG. 2 depicts a software configuration for an edge environment for managing a plurality of EVSEs, according to aspects provided herein;

FIGS. 3A-3C depict device configurations for an edge environment for managing a plurality of EVSEs, according to aspects provided herein;

FIGS. 4A-4C depict hardware that may be utilized for the devices from FIGS. 3A-3C according to aspects provided herein;

FIG. 5 depicts a software configuration for a cloud environment for managing a plurality of EVSEs, according to aspects provided herein;

FIGS. 6A and 6B depict example process flows for managing a plurality of EVSEs, according to aspects provided herein;

FIG. 7 depicts an example of an internal submetering system for managing a plurality of EVSEs, according to aspects provided herein;

FIG. 8 depicts an example of an external submetering system for managing a plurality of EVSEs, according to aspects provided herein;

FIG. 9 depicts a method for managing a plurality of EVSEs, according to aspects provided herein; and

FIG. 10 depicts an example processing system configured to perform the methods described herein.

### DETAILED DESCRIPTION

Aspects disclosed herein include systems and methods for managing a plurality of electric vehicle supply equipments (EVSEs). Some aspects provide an aggregated submetering system (e.g., an aggregated virtual submetering system) for EVSEs. Aspects of systems and methods for managing a plurality of EVSEs, incorporating the same, will be described in more detail, below.

With respect to a charging site (also referred to herein as a site), “submetering” may refer to isolating or managing electricity use for certain use cases (e.g., for electric vehicle (EV) charging) separately from other electricity uses. The submetering may be useful in some cases, such as for applying a different (e.g., preferential) treatment of the electricity use for certain use cases, such as for EV charging, compared to a treatment of electricity use for other use cases. As an example, a different (e.g., preferential) tariff—specialized plan related to adjusting cost for electricity use—may be applied for EV charging, compared to other (e.g., conventional) types of electricity use at the site.

Certain technical problems and/or challenges may exist for managing a plurality of EVSEs, such as for a site. An example of the challenges for managing a plurality of EVSEs may be related to installing a physical meter or submeter (e.g., a physical EV meter or a physical EV submeter) being expensive and time-consuming. While a physical utility-grade meter may enable certain submetering mechanisms for a site, it is too expensive to be practical in many cases. For example, installing a physical meter may require coordinating with an electric utility (e.g., an electric utility service provider), which causes an impractical delay for deployment. In some cases, installing a physical meter may require downtime to allow a whole EVSE system to be de-energized to allow for installation of the meter.

One approach to address the above challenge may be to install or provide submeters and/or dedicated EV charging services to a customer free of charge. However, this may mean that the installed equipment would be utilized in a rate-based manner and thus paid for, at least in part, by other electricity customers. Thus, this approach is not a practical solution in terms of cost, much less a permanent solution.

Another challenge may be that, without a submeter or a dedicated meter, a site may not be able to access preferential tariffs (e.g., for EV charging) provided by certain utilities. Certain utilities (e.g., electric utilities) offer preferential tariffs for EV charging, which provide certain incentives, such as reduced energy cost, lower- or no-demand chargers, and/or other incentives. These incentives often require EV charging to be metered separately from other loads. Moreover, other programs and/or offerings of some utilities may also require EV charging to be metered separately from other loads. For example, some utilities may offer dynamic tariffs which change periodically (e.g., hourly) or energy prices that may be based on wholesale market rates or demand response programs (e.g., incentivizing EV drivers to charge during off-peak hours or reduce charging speeds during high-demand grid events). In these cases, a controllable EV charging load (e.g., controllable for varied charging speeds, etc.) may be managed (e.g., metered) separately from other unmanaged loads at a site.

In some cases, where an electricity bill is paid by one party while EV charging decisions are made by a different party, there may be a principal-agent problem where the party making decisions about how to charge EVs may be unaware of the incentives such as the dynamic tariffs or prices. In certain cases, even when the party making the decisions about how to charge the EVs may be aware of the incentives, they may not (e.g., directly) benefit from shifting their load in response to the incentives. This principal-agent problem may reduce the effectiveness of the incentives to benefit the grid, and may result in increased cost to many parties.

One approach to address the principal-agent problem and related challenges may be to install a physical submeter or a dedicated meter, which would be subject to the first example of problems and challenges described above. Another approach to address the principal-agent problem and related challenges may be to use load management to optimize the EV charging load to reduce costs while the EV charging load stays on the same meter as other loads. In some cases, this approach may not be practical and/or may be expensive depending on the tariffs and/or usage patterns.

Yet another challenge associated with managing a plurality of EVSEs at a site may be that it can be difficult to accurately divide electricity costs between different parties or entities of the site, associated with their respective subsets of the plurality of EVSEs (e.g., tenants or departments, etc.). In certain cases, a shared EV charging system at the site may need to divide energy use, costs, and/or incentives (e.g., fairly, proportionally, or based on a defined standard) between the different tenants and/or departments of the site based on actual usage. Not only would this be at least a tedious and time-consuming process which requires aggregating energy usage for the chargers assigned to particular groups of tenants and/or departments, then calculating energy costs for the respective groups based on the tariff for the site, and then generating bills or invoices to each tenant or department (which may then be paid to a site host such as a landlord or a facilities department), but it is impractical or impossible to assign all costs and/or incentives to the different groups since these costs and/or incentives are non-linear. For example, demand charges for the site may be based on a maximum power draw over the course of a billing period (e.g., at a given point in time). Assigning this cost among users proportionally may be impractical or impossible. It may also be impractical or impossible to assign certain fixed costs among the users, where the fixed costs are not dependent on usage (e.g., directly).

One approach to address this challenge may be to have the party paying the electricity bill set certain (e.g., basic) rates, such as $ per kilowatt-hour ($/kWh) rates, which may be an attempt to cover the costs based on average. However, this approach can be problematic since these rates would need to be recalculated periodically to account for utility cost changes and/or changes in usage patterns, etc. Thus, this approach may not guarantee (e.g., accurate) cost recovery. For example, these rates may or may not account for grid signals like time-of-use or dynamic pricing.

Furthermore, another example of the challenge for managing a plurality of EVSEs at a site may be that a physical meter that has been installed at the site may be impossible or impractical to reconfigure (e.g., its submetering scheme) as needs change. For example, for a multi-unit dwelling (MUD) unit, one approach for metering EV charging may be to connect each EVSE to a particular unit's meter. However, this approach may be inflexible since certain chargers may be unused if a tenant of a particular unit does not have an EV. Likewise, this approach may be impractical (and, for example, increase costs) for a shared charging system for managing a plurality of EVSEs for the MUD unit in some cases, as the shared charging system cannot be designed efficiently, for example, by installing chargers near an electrical room, minimizing conduit runs, and/or oversubscribing infrastructure to minimize costs.

Similar challenges may exist for fleet departments, subcontractors, or commercial real estate tenants. In these cases, physical metering may prevent a site from being reconfigured as the needs of its users change over time. As tariffs change, the optimal configuration of submetering may also change, for example, where certain solutions may require metering the EV charging load separately from other loads, while the tariffs may change the optimal configuration in some cases such that it may be more efficient to combine metering for the EV charging load with metering for other building load(s). This combining may be impossible with a dedicated service and/or may be impractical with a physical submeter.

For dedicated meters, one approach to address the above challenge (e.g., an only option in some cases) may be to physically change the electrical connections, which is not practical in most cases. For physical submetering, it may be impractical to add or remove submeters arbitrarily (e.g., without significant costs).

Additionally, another challenge associated with managing a plurality of EVSEs at a site may be that it is difficult to combine multiple physical submeters with load management. For the site to use load management to share physical infrastructure such as a transformer or subpanel, physical submetering may not be an option. Physical submeters may need to be downstream (e.g., by a great extent) of a main meter and panel, which may make their installation impractical or impossible depending on a physical layout of the site and utility rules. For the site to submeter multiple groups of chargers, each group may need its own subpanel below the submeter, which would add to cost and complexity, making load management impractical or reducing the flexibility of load management.

Yet another example of problems and/or challenges associated with managing a plurality of EVSEs at a site may be that physical meters and existing submetering schemes may assume a static mapping of EVSEs to submeters, which prevents roaming (e.g., using a single account to access chargers operated by different networks). In some cases, an allocation between tenants and/or departments and physical EVSEs may not be stationary. For example, a site may have a collection of shared EVSEs that can be used by multiple departments or tenants. However, the site may still separate the loads onto (e.g., virtual) submetering schemes to disaggregate usage and allow accurate billing. Generally, when multiple tenants and/or departments use unassigned EVSEs, the only option for billing may be to bill on a per-session basis.

Certain aspects described herein may overcome the aforementioned technical problems and/or challenges (such as the impracticality in addressing the problems and/or challenges described above with respect to certain existing solutions or approaches), for example, by an aggregated virtual submetering system. In some aspects, an example method may include obtaining meter data from a plurality of EVSEs (e.g., of a site). A first portion of the meter data may be assigned to a first submeter grouping associated with at least a first EVSE of the plurality of EVSEs, while a second portion of the meter data may be assigned to a second submeter grouping associated with at least a second EVSE of the plurality of EVSEs. The example method may include determining aggregate meter data of each submeter grouping, such as for a defined period of time, and the aggregate meter data may be transmitted to a service provider, such as an electric utility, a charging service provider, an accounting or billing service provider, etc. In some cases, the aggregate meter data may be formatted in a defined format associated with the service provider, such that the aggregate meter data may be correctly received and processed by the service provider. While certain aspects are described with respect to submeter groupings for a charging site or similar, other examples of the systems or methods may also be possible, where the submeter groupings may be for a plurality of EVSEs that are located at or associated with multiple sites (e.g., behind multiple meters).

Some aspects may allow an operator or a user, such as a site host or an operator/user of a service provider to divide their chargers into groups (e.g., subsets of EVSEs of a plurality of EVSEs at a site), each of which can be assigned to a virtual submeter (e.g., a submeter grouping) associated with its respective tariff or similar. For example, a separate utility bill may be generated for each submeter grouping. Each of these virtual submeters (submeter groupings) may be associated with its own utility tariff. These aspects may allow the site host to select how each group or subset of EVSEs may respond to price signals, such that each group may be optimized against its own prices or grid signals. While these EVSEs may be logically separated (e.g., metered or managed separately), such as for billing purposes, they may still share certain infrastructure constraints via a centralized load management that allows for oversubscription of local infrastructure and utility interconnection limits. Some aspects of the virtual submetering system described herein may allow the site host to define groups of users who can be assigned to submeter groupings rather than (e.g., only) relying on assigning physical EVSEs to groups. This capability provides the technical benefit of submetering while allowing for certain subgroups of users (e.g., of tenants and/or departments) to share EVSE infrastructure. This capability is particularly advantageous when certain EVSEs (e.g., direct current fast charging (DCFC) equipments) are being used, since such relatively expensive equipments may be likely to be shared between users.

Certain techniques for managing a plurality of EVSEs at a site, such as via an aggregated virtual submetering system described herein, may provide various beneficial technical effects and/or advantages. Because certain aspects leverage meters built into EVSE, there may be no added hardware costs for implementing the aggregated virtual submetering system described herein. Moreover, the software-defined submetering system may allow arbitrary grouping and re-grouping of EVSEs, which enable a site to adapt to changing conditions, such as changing tariffs and/or usage patterns. Accordingly, the aggregated virtual submetering system described herein may overcome the impracticalities described above. As an example, a site may initially have its EVSEs split into (e.g., assigned to) two submetering groups for two existing groups (e.g., tenants). Then, one or more EVSEs of the two submetering groups may be split into (e.g., re-assigned to) a new submetering group (e.g., a third virtual submeter for a particular tenant), such as at a later time. Certain aspects may provide the site host (or certain users) sufficient permissions to self-service the grouping and/or re-grouping of EVSEs and assignment of groups of EVSEs to virtual submeters. Some aspects may allow for submetering to work seamlessly with adaptive load management to allow a site to stay below local and/or grid-level constraints (e.g., simultaneously) while also enabling the submetering schemes described herein. Certain aspects may enable each submetering group to adaptively respond to changing price signals, which may also be compatible with the adaptive load management, such that a site may enforce hard infrastructure limits while simultaneously making it practical to respond to various changing price signals (e.g., without incurring added cost or delay in deployment).

### Example Computing Environment for Managing a Plurality of EVSEs

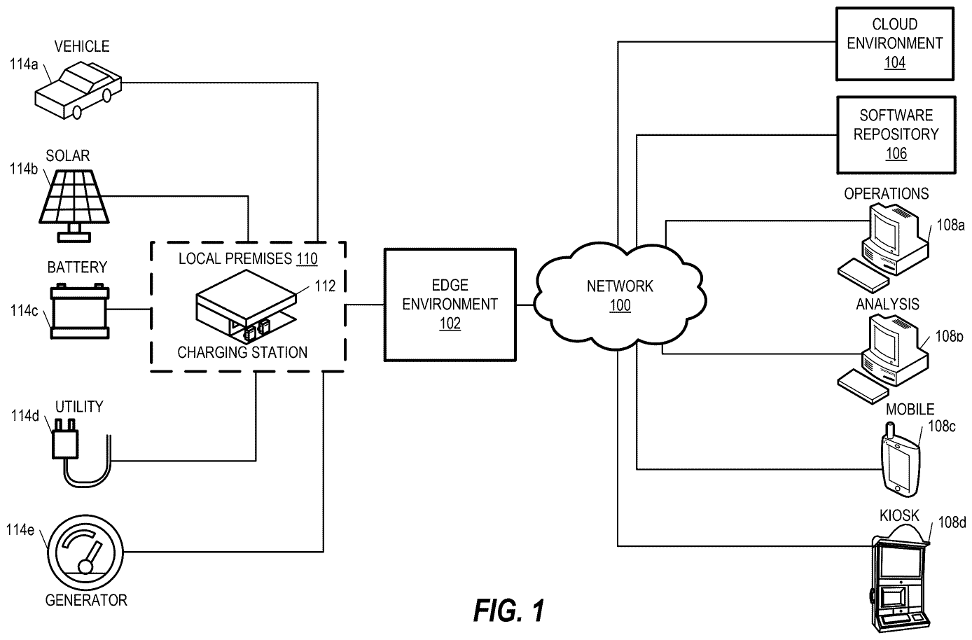

Referring now to the drawings, FIG. 1 depicts a computing environment for managing a plurality of EVSEs, according to aspects provided herein. As illustrated, the computing environment includes a network 100 that is coupled to an edge environment 102, a cloud environment 104, a software repository 106, as well as one or more ancillary devices 108 (including an operations device 108a, an analysis device 108b, a mobile device 108c, and/or a kiosk device 108d). The network 100 may be configured as any wide area network (WAN, such as the internet, power network, cellular network, etc.) or other network for facilitating communication among the edge environment 102, the cloud environment 104, the software repository 106, and the ancillary devices 108.

Edge environment 102 may generally be deployed at a local premises site 110 (also referred to herein as a site) to provide various services, including coordination and optimization of one or more energy assets 114 (including an EV 114a, a solar device 114b, a battery energy storage system (BESS) 114c, a utility grid 114d, and/or a generator 114e), such as charging of electric vehicles (e.g., EV 114a) using charging station 112 and controlling one or more of various distributed energy resources (DERs), such as solar device 114b, BESS 114c, utility grid 114d, and/or generator 114e (e.g., an on-site diesel, natural gas, or other type of fueled generator). Generally, the aforementioned DERs may provide energy to the charging station 112 and/or use energy from the charging station 112 (e.g., by way of a backflow of energy from EV 114a to other aspects of site 110). In some aspects, charging station 112 may send excess energy back to the BESS 114c and/or to utility grid 114d. Generally, edge environment 102 may monitor and/or modify the energy sent to and received from the DERs to optimize various tasks, such as charging of EV 114a.

Charging station 112 may utilize one or more of various communication protocols, such as open smart charging protocol (OSCP), open charge point interface (OCPI), ISO 15118, OpenADR, open charge point protocol (OCPP), etc. and may represent Level 1, Level 2, Level 3 (e.g., DC Fast Charging), and higher level charging stations, as applicable. Generally, the “level” of a charging station refers to the power level and/or ability to provide electric power to a device being charged.

Edge environment 102 is configured as an interface between various aspects of site 110 and network 100. In various aspects, compute resources for performing different functions at a site, such as control or optimization of EV charging, may be split between local compute resources in edge environment 102 and remote compute resources, for example, in cloud environment 104 of FIG. 1.

Cloud environment 104 is coupled to the edge environment 102 via the network 100 and may be configured for further processing of data, as described herein. While FIG. 1 depicts a single cloud environment 104 that serves a single edge environment 102, this is merely an example, as some aspects may be configured such that the cloud environment 104 may serve a plurality of edge environments 102 that each serves one or more sites 110, one or more charging stations 112, one or more DERs, and the like.

Software repository 106 is also coupled to site 110 via network 100. Software repository 106 may be configured as a platform to program, store, manage, control changes, etc. to software that is implemented in edge environment 102 and/or cloud environment 104. In some aspects, software repository 106 may be configured as a proprietary service and/or may be provided by a third-party, such as GitHub™. Additionally, some aspects may be configured such that the software repository 106 is provided by the same entity that manages the cloud environment 104. As such, these aspects may be configured such that software repository 106 and cloud environment 104 may be combined.

With respect to the ancillary devices 108, the operations device 108a may be utilized to monitor and/or alter operations of the computing environment provided in FIG. 1. The analysis device 108b may analyze utilization, operation, charging, and/or other features of the computing environment provided in FIG. 1. The mobile device 108c may represent an administrator device and/or a user device. As a user device, the mobile device 108c may initiate charging, perform payment, and/or perform other user-specific actions. As an administrator device, the mobile device 108c may perform administrative operations, analysis, and/or other actions. The kiosk device 108d may be located at one of the charging stations 112 and/or remote therefrom and may provide user-specific or administrative actions, similar to that of the mobile device 108c. In some aspects, one or more administrators may use the kiosk device 108d to view information about a site or make changes. As will be understood by one of ordinary skill in the art, the ancillary devices 108 may each include one or more processors, one or more memory components, and/or other hardware and/or software for performing the functionalities provided herein. It should be understood that while the kiosk device 108d is depicted as being remote from the site 110, some aspects may not be configured in this manner. Specifically, some aspects may utilize a kiosk device 108d that is local at the site 110, which may communicate via a local network and/or the network 100 for providing the services described herein.

### Example Edge Environment for Managing a Plurality of EVSEs

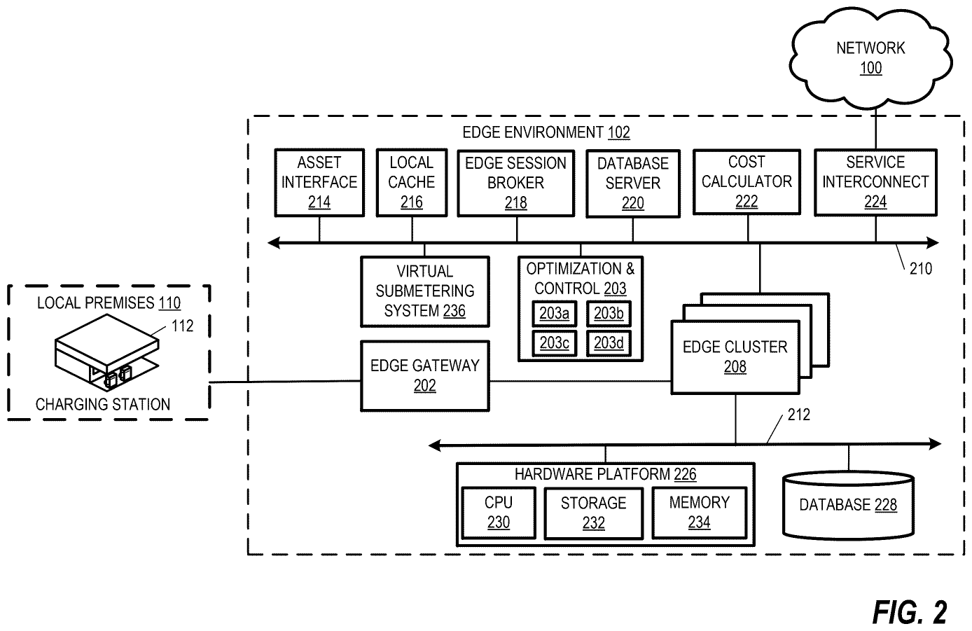

Referring now to FIG. 2, the edge environment 102 may be coupled to the site 110 via an edge gateway 202. Edge environment 102 may be operatively coupled to aspects of site 110, such as charging station 112 via edge gateway 202. Edge environment 102 further includes an edge cluster 208, which is coupled to communication bus 210 and hardware bus 212. Communication bus 210 is coupled to optimization and control manager 203, asset interface 214, local cache 216, edge session broker 218, database server 220, cost calculator 222, service interconnect 224, and virtual submetering system 236 in this example. Hardware bus 212 is coupled to hardware platform 226, which may include one or more processors, such as CPU 230, one or more storage components 232, one or more memory components 234, and/or other hardware components. Also coupled to hardware bus 212 is database 228. Though certain components (e.g., cost calculator 222, database server 220, etc.) of edge environment 102 are depicted separate from hardware platform 226, they may be services or processes configured to run on hardware platform 226. Further, though certain components are illustrated as separate components, the functionality of such components may be combined into a single component and/or further divided among additional components.

Communication bus 210 and hardware bus 212 may be utilized to facilitate operation of all services that run in edge environment 102 and communicate with each other via a distributed message streaming system. The coupling of the aforementioned services may be accomplished in some aspects via a distributed message streaming system, such as NATS.

In the depicted example, charging station 112 is configured for communication with edge environment 102 via edge gateway 202, such as via a short-range wireless network technology, such as via a Zigbee® PAN. The edge gateway 202 may be configured to receive data, such as electric vehicle charging data, price change data, vehicle data, etc. from the charging station 112 and/or vehicles that are being charged via the connection with the site 110 (of FIG. 1).

In some aspects, edge gateway 202 may be configured to abstract data received from various aspects of site 110 (of FIG. 1), such as charging station 112, to remove protocol-specific distinctions. For example, a first charging station may utilize a first communication protocol and/or billing protocol and a second charging station may utilize a second communication protocol and/or billing protocol. Edge gateway 202 may receive data packets from both the first charging station using the first communication protocol and the second charging station using the second communication protocol and may transform the received data into a protocol-agnostic format prior to providing the data to edge cluster 208. This may allow wide interoperability between edge environment 102 and various types of hardware (e.g., charging station 112) at a site.

Edge cluster 208 is the central message center in various aspects. For example, when a user plugs a vehicle into a charging station 112, edge cluster 208 receives data from edge gateway 202, parses that data (e.g., to generate access state data) and causes the state data to be sent to the database server 220. Edge cluster 208 also receives the data and creates a session entry, which may be stored in the local cache 216. Edge cluster 208 may additionally send the session entry to the cloud environment 104 (of FIG. 1) via network 100. Edge session broker 218 may also receive data related to the new session and may query database server 220 to access additional session data to determine charging characteristics for charging station 112.

The edge session broker 218 may produce data or signals that are sent to the edge cluster 208, which may be sent to the edge gateway 202 for potentially sending back to one or more of the charging stations 112. Information that may be reported might include current delivered over time (e.g., amperes), total energy delivered (e.g., kWh), power delivered over time (e.g., kW), voltage at the charging station over time (e.g., V), charging station state (e.g., connected, disconnected, offline), connectivity state, charging state, etc. The charging stations 112 may report any errors back to the edge cluster 208. The cost calculator 222 may be engaged to access pricing data from the cloud environment 104 and may calculate costs incurred based on delivered energy, expected costs prior to charging, idle time interval, parking time interval, etc. The asset interface 214 may be a software interface between the edge environment 102 and the energy assets 114.

Edge cluster 208 may be configured such that any message received by the edge cluster 208 may also be sent to the cloud environment 104 (of FIG. 1) for consumption by a data subscriber in the cloud environment 104. For example, if a user of the mobile device 108c (in FIG. 1) desires to claim a charging session, mobile device 108c does not need to access edge environment 102 directly. Instead, mobile device 108c may connect with the cloud environment 104 (of FIG. 1), which sends a message to the edge cluster 208 with an instruction to claim the session. Service interconnect 224 is configured for establishing an HTTP, TCP, and/or other type of communication with the cloud environment 104 (of FIG. 1) via network 100.

The optimization and control manager 203 may provide energy optimization and adaptive load management (ALM) functions, for example, for various energy assets 114 at the site 110 (of FIG. 1). For example, the optimization and control manager 203 may be responsible for calculating set-points for each asset for the energy optimization and ALM amongst the energy assets 114 and providing data related to the calculated set-points to the asset interface 214. A set-point may be a value for a parameter (or a set of values for a set of parameters), such as a charging rate. In certain aspects, the optimization and control manager 203 may include a database layer 203a to store data related to site configurations; an orchestration layer 203b to gather data, trigger optimizations, and/or issue set-points (e.g., provide the calculated set-points to energy assets); an optimization layer 203c to formulate and solve optimization problems to calculate set-points; and/or a control layer 203d for higher frequency feedback based controls (e.g., for modifying set-points to respond to fast time-scale events).

Optimization and control manager 203 may determine when optimization set-points need to be updated. Examples of when optimization set-points need to be updated include, but are not limited to: (1) when a new energy asset is installed at a site, (2) when a new vehicle to be charged arrives at a site, (3) when a measured value such as load or generation changes, (4) when a system parameter such as the target energy for a vehicle is updated, (5) when an external event occurs (such as a demand response event), and/or (6) at a fixed cadence (e.g., every 5 minutes). When it is determined that the optimization set-points need to be updated, optimization and control manager 203 may collect data needed for optimization, including optimization configuration from the cloud environment 104 of FIG. 1 (which can also be cached at edge environment 102) and state information from edge environment 102 and/or cloud environment 104. Examples of the optimization configuration include, but are not limited to: network and equipment constraints, optimization parameters such as the precision and timeout settings, etc. In certain aspects, the state information from edge environment 102 and/or cloud environment 104 includes the states of the energy assets, as well as other state information including EV driver preferences, price signals, and grid signals. Further, optimization and control manager 203 may perform optimization to calculate new/updated set-points. In certain aspects, optimization and control manager 203 may (e.g., optionally) run a fast time-scale control loop which adjusts set-points in real-time in response to fast changing signals, such as building load, solar generation, or grid signals. In some aspects, the functionalities of the optimization and control manager 203 may be implemented, at least in part, within the cloud environment 104 (of FIG. 1).

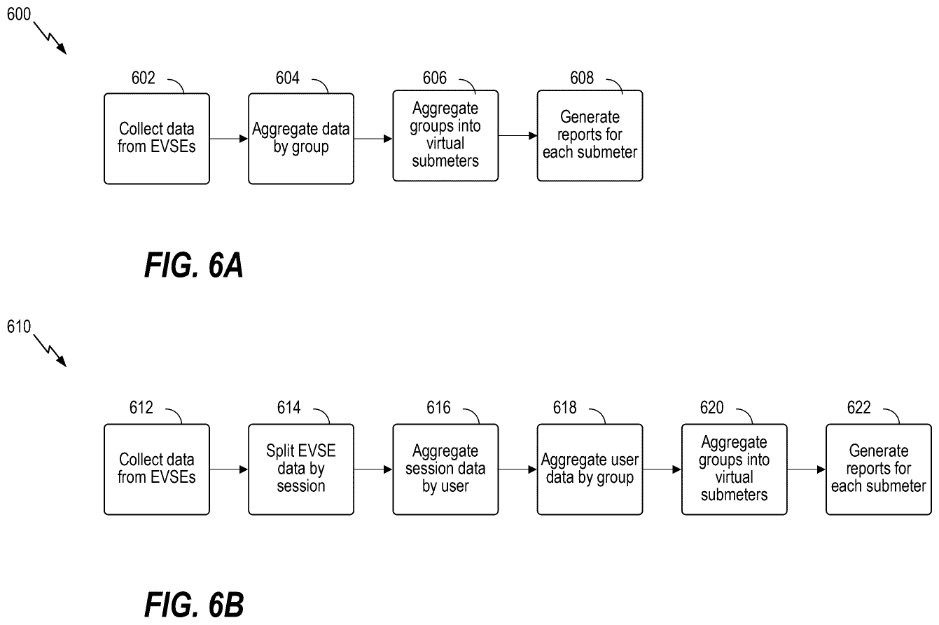

Virtual submetering system 236 is configured to provide the hardware and/or software components for facilitating the processes and actions (e.g., as may be accessed and/or implemented via the edge environment 102) of the virtual submetering system described herein with reference to, for example, FIG. 6A, 6B, 7, or 8.

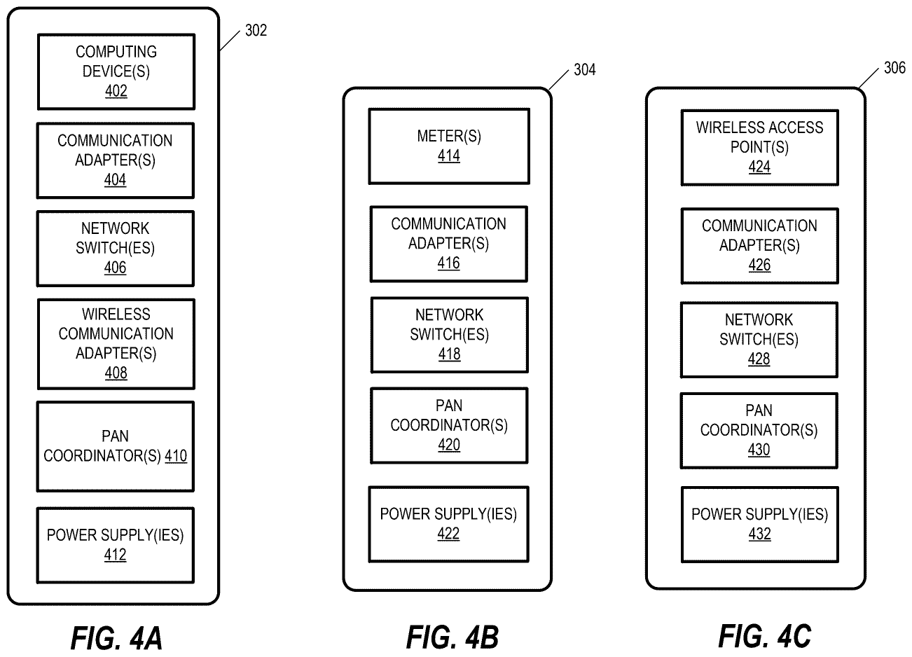

Hardware platform 226 represents any hardware for facilitating the processes and actions described herein. Specifically, one or more CPUs 230 may represent one or more types of processing device configured for executing instructions. One or more storage components 232 may be configured as long term storage, such as a hard drive or the like. One or more memory components 234 may include any of various types of random access memory or the like. One or more databases 228 may be configured for additional storage and may be housed with the other hardware and/or elsewhere. Examples of different hardware platforms that may be deployed in edge environment 102 are described further below with respect to FIGS. 4A-4C.

### Hardware Configurations for Edge Environment

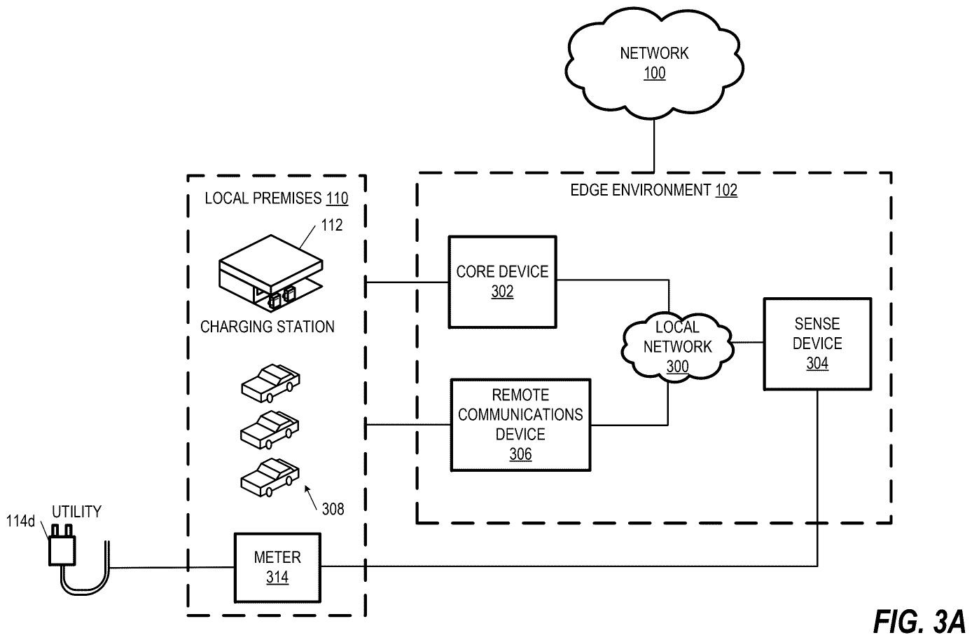

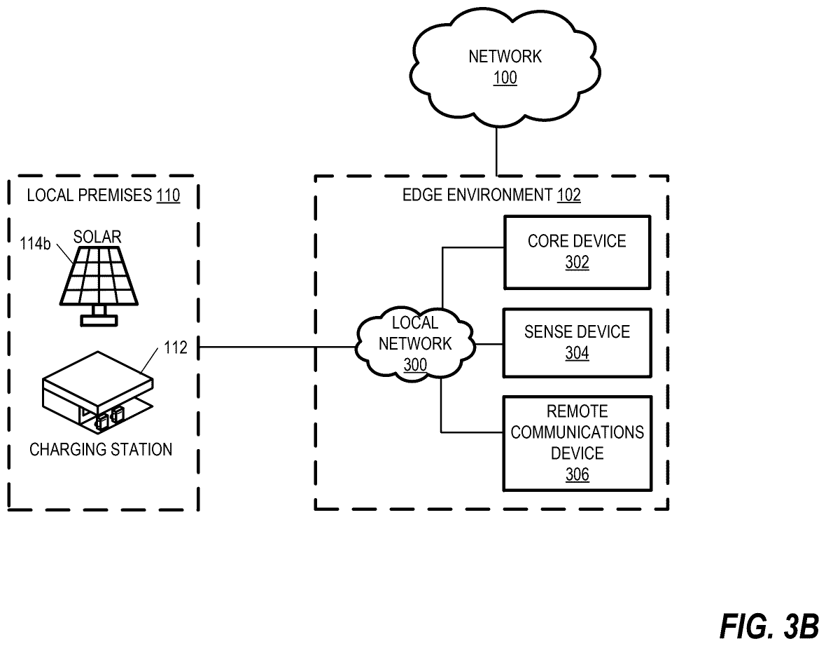

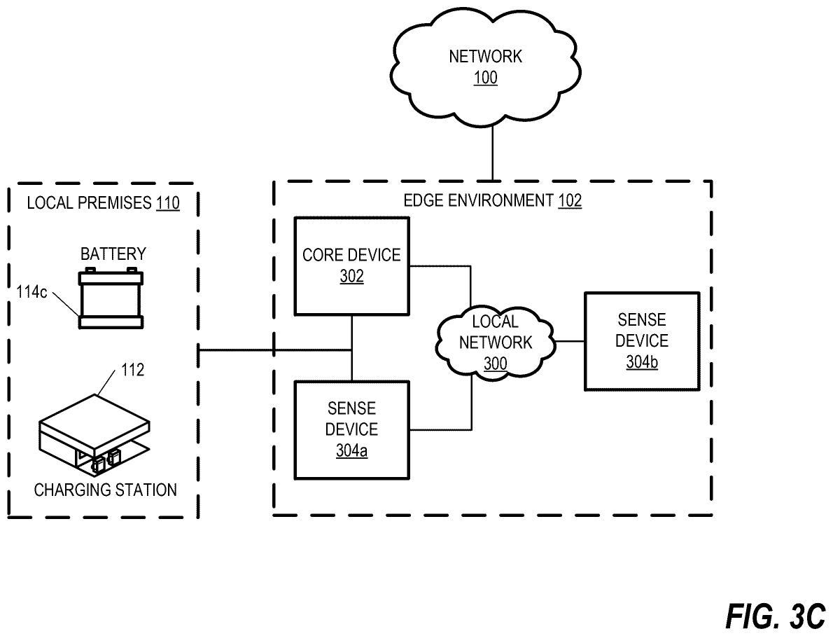

FIGS. 3A-3C depict example device configurations for edge environment 102, according to aspects provided herein. Specifically, FIG. 3A depicts a charging solution. As illustrated, the charging station 112 is coupled to a local network 300 via a core device 302. The local network 300 may include any local area network, Ethernet, PAN, etc. The core device 302 may be physically installed within communications range of one or more chargers in the charging station 112. A sense device 304 may be installed, for example, in an electrical room or in another enclosure with electrical equipment of the charging station 112 and/or one or more energy assets 114 to monitor the main metering point for the local utility point of common coupling. This may enable one or more algorithms to provide the optimal dispatch of EV charging power, subject to local energy rates and the vehicles currently charging. In the case that there are vehicles 308 using EV chargers that are out of communications range of the core device 302, such as a sub-level of a parking garage, one or more remote communications devices 306 may be included. In certain aspects, at least one of the one or more remote communications devices 306 may be in data communication with the charging station 112 (e.g., having one or more EV chargers charging one or more vehicles 308) and/or vehicles 308. Also included at the site 110 is a meter 314 for communicating energy with the utility grid 114d.

The core device 302 shown in FIG. 3A is the central processing device and serves as the communications hub. In certain aspects, the components of FIG. 2 may generally operate, at least in part, as part of the core device 302. The core device 302 may provide optimization, load management, communication coordination, and/or data historian services. The core device 302 may communicate with the cloud environment 104 via cellular modem, wired internet service provider (ISP), and/or other communications medium to get current optimization and load management set-points for charging stations 112 and/or other assets, such as via an optimization algorithm that may be stored locally and/or at the cloud environment 104. It will be understood, however, that some aspects may be configured such that the core device 302 performs optimization locally. In certain aspects, the core device 302 dispatches these set-points, through a local communications protocol (e.g., Wi-Fi) and/or via the remote communications device 306 to reach locations that are distant or hard to reach, such as charging stations with a core device 302 and/or sense device 304 at sub-levels of a parking garage or a rooftop solar inverter. The core device 302 may additionally or alternatively collect data directly from distributed energy resources and power measurement devices or through cloud-based communications with the network 100.

Power and energy metering data may be collected via the sense device 304. The sense device 304 may include a smart meter with support for multiple single- and three-phase loads, such as with a local historian and Ethernet communication back to the device via the local network 300. The sense device 304 may also incorporate support for additional devices running on the edge including but not limited to thermocouple wiring, weather stations, temperature sensors, pyranometers, etc. It should be noted that additional sense devices 304 and remote communications devices 306 can be added to handle a variety of situations, such as a separate subpanel for energy metering of a new solar system or for monitoring of a new inverter associated with a rooftop solar installation.

FIG. 3B depicts a solar application where the core device 302 and the sense device 304 are installed in an electrical room or other common area. The sense device 304 can monitor the main metering point for the local utility as well as the solar production at tie-in breakers for the solar device 114b. The remote communications device 306 may be installed in a position to communicate directly with the solar device 114b and report the data received from the solar device 114b to the core device 302. Accordingly, the core device 302, the sense device 304, and the remote communications device 306 depicted in FIG. 3B may perform similar functions as those devices depicted in FIG. 3A.

FIG. 3C depicts a battery application where the core device 302 and the sense device 304 (including a first sense device 304a and a second sense device 304b) are installed physically near the BESS 114c. In some cases where the BESS 114c is near the point of common coupling with the utility grid 114d, a single sense device 304a can monitor the full site. In some cases where there is a significant distance to the metering point for the utility grid 114d, the second sense device 304b (or a plurality of second sense devices 304b) may be installed near the utility meter, such as the electrical room.

### Hardware Components in Core, Sense, and Remote Communications Devices

FIGS. 4A-4C depict hardware that may be utilized for the devices from FIGS. 3A-3C according to aspects provided herein. Specifically, FIG. 4A depicts hardware components that may be present in core device 302. In some aspects, the core device 302 is the brain where the energy optimization and adaptive load management (ALM) functions (e.g., by the optimization and control manager 203 of FIG. 2) are executed and dispatched. As illustrated, the core device 302 may include one or more computing devices 402, one or more communication adapters 404, one or more network switches 406, one or more wireless communication adapters 408, one or more PAN coordinators 410, and/or one or more power supplies 412. As will be understood, the computing device(s) 402 may include one or more processors, one or more memories, and/or other components that a conventional, specific-purpose machine may utilize. In some aspects, the computing device(s) 402 may include power line communication (PLC) infrastructure, while some aspects may utilize retail and/or micro-industrial computer components for optimization, load management, communication coordination, and/or historian services.

The communication adapter(s) 404 may be configured for load balancing and otherwise managing communications of, for example, Modbus RTU (RS485) to Modbus TCP (Ethernet) or Ethernet IP (RJ45) to Ethernet Optical (SFP), etc. The network switch(es) 406 may be configured for routing of network traffic, and may be configured as an Ethernet switch for communication to other nodes (e.g., the sense device 304, the remote communications device 306, and/or other core device 302), distributed energy resources, and/or energy based management systems.

The wireless communication adapter(s) 408 may include a cellular modem, internet modem, Wi-Fi access point, etc. for facilitating wireless communications to the internet or other wide area network. Similarly, the PAN coordinator(s) 410 may be configured to create and/or join communication connections with other devices. This may include a Zigbee coordinator, Bluetooth device, and/or other device for performing this function. The power supply (ies) 412 may be configured as battery power, connection to external power, etc.

FIG. 4B depicts hardware components of the sense device 304 from FIGS. 3A-3C. The sense device 304 may be configured as a smart-metering piece for collection and storage of power/energy data such as measurements such as temperature, voltage, current, power, solar irradiance, wind speed, etc. The sense device 304 may include a smart meter with multiple channels of measurement that may comprise single-phase circuits and/or three-phase circuits. The sense device 304 may communicate meter data back to the core device 302 from meter locations such as electrical rooms, rooftop solar installations, EV chargers, and subpanels. Certain aspects may be optimized for ease of installation and reduced intrusion to the site. Power over Ethernet (PoE) sourced from the core device 302 may suffice for most installations. The sense device 304 may transmit data back to the core device 302 via a network switch. The sense device 304 may be optimized to utilize minimal power, and PoE may be acceptable for most installations.

As illustrated in FIG. 4B, the sense device 304 includes one or more meters 414, one or more communication adapters 416, one or more network switches 418, one or more PAN coordinators 420, and/or one or more power supplies 422. The power supply (ies) 422 may include a power interface for providing power to the sense device 304. In certain aspects, the meter(s) 414 may be power meter(s) utilized for monitoring single-phase and three-phase loads of power. The communication adapter(s) 416 may be utilized for facilitating communications between the sense device 304 and other devices. The network switch(es) 418 may be a PoE enabled switch for communication. Similarly, the PAN coordinator(s) 420 may create and/or join personal area networks, such as via Zigbee, Bluetooth, and the like. In some aspects, PoE or other power source may be utilized.

As illustrated in FIG. 4C, the remote communications device 306 may be a network-connectivity extension, for example, for EV charging or solar monitoring locations where Zigbee, Wi-Fi, or Ethernet is being extended to remote or difficult-to-reach locations such as remote subpanels, parking garage levels, or rooftop inverters. Some aspects are optimized for ease of installation and reduced intrusion to the site where PoE may suffice for most installations from the core device 302. The remote communications device 306 may be configured to transmit data back to the core device 302 via a network switch.

Specifically, the remote communications device 306 may include one or more wireless access points 424, one or more communication adapters 426, one or more network switches 428, one or more PAN coordinators 430, and/or one or more power supplies 432. The wireless access point(s) 424 may be configured to extend wireless communication signals to chargers and/or other intelligent electronic devices. The communication adapter(s) 426 may be configured for facilitating communications between the remote communications device 306 and other devices. The network switch(es) 428 may be configured as a PoE Ethernet switch and/or other network switch for communicating with the core device 302. The PAN coordinator(s) 430 may be configured to create and/or join personal area networks, such as via Zigbee, Bluetooth, and the like. The power supply (ies) 432 may include a power interface for providing power to the remote communications device 306.

### Example Cloud Environment for Managing a Plurality of EVSEs

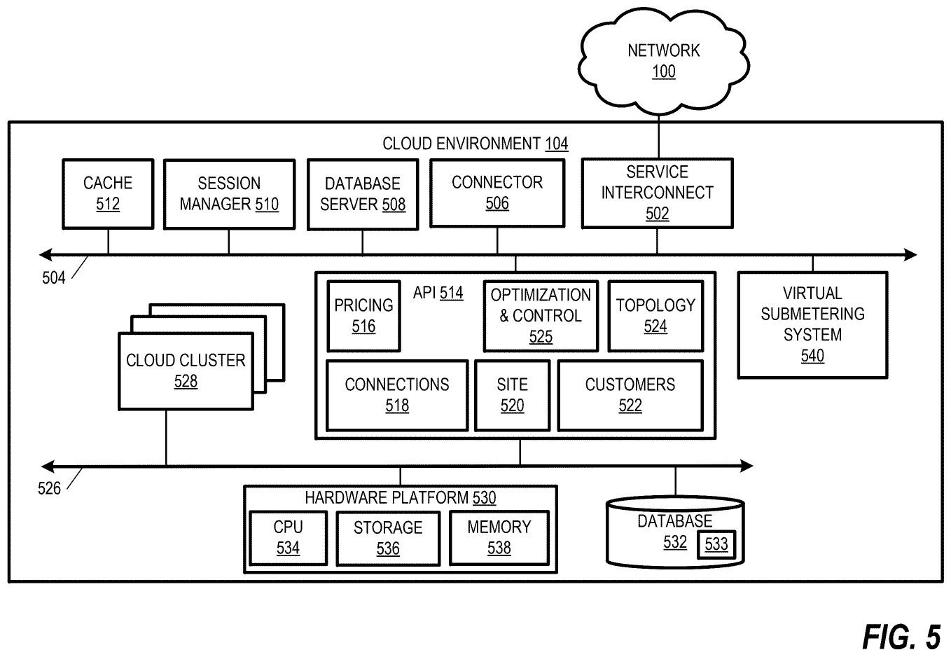

FIG. 5 depicts a cloud environment for managing a plurality of EVSEs, according to aspects provided herein. As illustrated, the network 100 may couple to the cloud environment 104 via a service interconnect 502 that corresponds with the service interconnect 224 from FIG. 2. Similar to the service interconnect 224 from FIG. 2, the service interconnect 502 may be configured to facilitate an HTTP, TCP, and/or other communication portal through the network 100 to the edge environment 102 for the exchange of data between the edge environment 102 and the cloud environment 104. Additionally or alternatively, the service interconnect 502 may be configured to facilitate an HTTP, TCP, and/or other communication portal through the network 100 directly with an electric vehicle supply equipment (EVSE), such as charging station 112, for the exchange of data between the edge environment 102 and the EVSE. For example, in some such aspects, cloud environment 104 may be configured with the same or similar components as edge environment 102 (e.g., in addition or alternative to one or more components shown in FIG. 5) and configured to perform functions similar to edge environment 102, such that a separate edge environment 102 may not be needed.

The service interconnect 502 is coupled to a communication bus 504, which facilitates communication among various components of FIG. 5. Also connected to the communication bus 504 are a NATS connector 506, a database server 508, a session manager 510, a cache 512, a collection of services and application programming interfaces (APIs) 514, and a virtual submetering system 540. The APIs 514 may include a pricing API 516, a connections API 518, a site API 520, a customers API 522, a topology API 524, and/or an optimization and control API 525. The APIs 514 may be implemented by hardware platform 530. Hardware bus 526 is coupled to a NATS cloud cluster 528, as well as the hardware platform 530 and a database 532. The hardware platform 530 may include one or more CPUs 534, one or more storage components 536, and one or more memory components 538. Though certain components of cloud environment 104 are depicted separate from hardware platform 530, they may be services or processes configured to run on hardware platform 530. Further, though certain components are illustrated as separate components, the functionality of such components may be combined into a single component and/or further divided among additional components.

The APIs 514 are a component of the cloud environment 104. As such, the APIs 514 (including the pricing API 516, the connections API 518, the site API 520, the customers API 522, the topology API 524, and/or the optimization and control API 525) may cause storage of and/or process site information, site topology, customers, connections to panels, constraints of panels, pricing information of each site, local forecasting services, optimization services, controller services, caching services, etc. The APIs 514 may also serve as a mobile backend by storing personal information of charge users (e.g., email, charging preferences, payment preferences, privileges, access, fleet information, etc.). The APIs 514 may additionally store peak charging configurations, data related to meter setup, etc. In some cases, the APIs 514 may also be responsible for tracking changes to EVSE connections and causing related changes to various types of data. For example, a newly connecting EVSE may create a new charging session, and a newly disconnecting EVSE may close a charging session. The connection and the disconnection may cause changes in payment information for user(s) of the connecting or disconnecting EVSE(s), for example, related to payment for energy usage. In some aspects, the pricing API 516 may be used for storing information related to pricing configuration of a charging site, such as the site 110 (of FIG. 1). Some examples of the information related to pricing configuration of a charging site may include, but not be limited to, cost for energy (e.g., $/kWh), cost for parking time (e.g., $/time-interval), cost for idle parking time (e.g., $/idle-time-interval), etc. In certain aspects, the site API 520 may be or include a service that provides an API to read or change information about a charging site (e.g., site name, address, etc.). The topology API 524 may be used for storing information related to topology of EVSEs, and may be utilized to track, for example, which EVSEs are connected to which electrical panels and whether any electrical panels may be subpanels of other panels. Such information may be utilized for load management. In some aspects, the optimization and control API 525 may be responsible for handling optimization requests, performing one or more optimization methods, and communicating the result of the optimization. For example, the optimization and control API 525 may be or include a service that may be executed when there is a newly connected or disconnected EVSE, such that an optimization may be performed to allocate (e.g., re-allocate) power according to updated state(s) of the EVSE(s). In some aspects, optimization and control API 525 may enable per-site configuration of the optimization and control parameters. For example, these parameters can be updated via API(s) 514 (e.g., optimization and control API 525) directly or via a front-end interface. These parameters may include different parameters for each optimization strategy as well as the grouping of strategies into stages. Moreover, optimization and control API 525 may be used to store (e.g., via database 532) input and output pairs (e.g., related to various optimization scenarios, where an input may correspond to a combination of the optimization configuration and system state and an output may correspond to a collection of parameters for how the system should operate, etc.) for subsequent analysis.

When a vehicle is plugged into a charging station 112 (FIG. 1), the edge session broker 218 (FIG. 2) may communicate connection information to the APIs 514. The connection information may include vehicle information, user information, charging station information, etc. The APIs 514 then create a charge session object, which is stored in the cache 512. The cache 512 sends the session data, along with topology constraints and the charge session object to the edge environment 102. The NATS connector 506 may additionally cause the NATS cloud cluster 528 to maintain the charge session object for retrieval by an interested party. As the session continues, the session manager 510 may be utilized to alter constraints of the session, which may cause the NATS cloud cluster 528 to update the charge session object.

When a user claims a previously created session with the mobile device 108c, the database server 508 may create a database entry (e.g., within the database 532) with the charge session, driver, energy request, willingness to pay, electricity purchased, etc. The NATS connector 506 may update the NATS cloud cluster 528 with the database entry. This data may then be sent to the edge environment 102. When the charge session ends (e.g., when the vehicle is unplugged), that action may be added to the database entry and the database entry may be moved from a current sessions list to a completed sessions list.

In certain aspects, the database 532 may include optimization data 533 related to, for example, optimization scenarios (e.g., past optimization scenarios which may be used for debugging and/or auditing the performance of a given optimization scheme).

Virtual submetering system 540 is configured to provide the hardware and/or software components for facilitating the processes and actions (e.g., as may be accessed and/or implemented via the cloud environment 104) of the virtual submetering system described herein with reference to, for example, FIG. 6A, 6B, 7, or 8.

As indicated above, the hardware platform 530 may represent hardware that may be utilized to execute the components described regarding FIG. 5. As such, the CPU(s) 534 may be configured as any processing unit for receiving and executing computer-readable instructions. The storage component(s) 536 may be configured as any hard drive or other local storage device. The memory component(s) 538 may be configured as any type of RAM, ROM, registers, etc. or the like.

### Example Aggregated Virtual Submetering Systems and Methods

Certain aspects of the present disclosure provide a submetering system (e.g., an aggregated virtual submetering system), which includes a Meter Data Management Agent (MDMA), to enable EVSE-level submetering. Some aspects may allow for accurate load segregation, enabling site hosts to provide EV-specific or dynamic control of EVSEs. For example, these aspects may allow adopting EV-specific or dynamic tariffs, and enable site hosts to optimize charging based on grid signals while not affecting their energy costs for other loads. Certain aspects may be implemented without incurring significant additional hardware costs, while ensuring scalability for chargers (e.g., California Type Evaluation Program (CTEP)-compliant chargers). Some aspects of the present disclosure provide various benefits that are focused on fleets, MUD units, workplace, and/or public charging.

Additionally, certain aspects of the present disclosure address technical challenges in vehicle-grid integration (VGI). For example, the Principal-Agent problem described above, where the party responsible for energy costs (e.g., facilities managers) may not be the same as the party managing EV charging (e.g., fleet operators), may be addressed. Moreover, a load separation problem, where shared meters may discourage participation in VGI programs due to the inability to isolate controllable EV loads from other building loads, may be addressed. For example, the aggregated virtual submetering system described herein may resolve these issues by enabling precise load disaggregation and targeted control (e.g., for targeted incentives).

Certain aspects of the present disclosure may quantify various benefits (e.g., the economic, environmental, and/or grid benefits) of submetering through modeling and real-world data analysis. The modeling and real-word data analysis may include evaluating cost savings for site hosts, drivers, and/or ratepayers under various scenarios, such as relating to dynamic tariffs and load separation. Moreover, some aspects may enable enhanced grid flexibility through VGI. By enabling dynamic tariffs and optimizing EV charging, certain aspects may optimize the energy transfer within or through a charging site such as to reduce strain on the grid.

Moreover, the scalability and flexibility of the aggregated virtual submetering system described herein may allow sites to adjust their metering configuration as grid signals change and/or as sites adopt other distributed energy resources (DERs) (e.g., solar and/or storage). For example, certain aspects may allow sites to segregate EV load from other facility load, while also enabling the sites to re-integrate some or all of the EVSEs onto a main meter, for example, as DERs are added and/or tariffs are changed.

Certain technical advantages of various aspects of the present disclosure, such as described with respect to FIG. 6A, 6B, 7, or 8, are as follows.

In some aspects, there may be some benefits in capital cost to customer and/or ratepayer. Certain benefits may be in the operational cost to customer, which may include the price that sites may pay for energy and demand charges as well as any fees they may pay to Charge Point Operators (CPOs) for managing charging and billing.

When an existing meter is used for metering EVSEs at a site, the EVSEs may not respond directly to grid signals due to the principal-agent problem described herein. Moreover, it may be difficult or impractical for sites to opt in to dynamic tariffs, for example, since opting in to dynamic tariffs could result in high costs (e.g., due to challenges in load segregation). In some cases, dedicated EV service and physical submeters may be exposed to grid signals, but may not be likely to implement active management based on costs or optimize the tariffs. Certain aspects of the present disclosure may address the principal-agent problem and/or the load segregation problem, and/or make it practical for sites (e.g., making it easier for them) to subscribe to the changing tariff (e.g., the best tariff) for them, which may reduce the strain on the grid. Certain advantages may also exist in the convenience of paying for electricity (e.g., having one utility bill per group, such as tenant and/or department), which addresses the principal-agent problem to allow VGI benefits. Moreover, certain aspects may enhance flexibility to reassign chargers as needed based on their operations (e.g., based on changing price signals), which may incentivize different submetering configurations. Such flexibility may also be extended to other DERs (e.g., solar and/or energy storage on site), where sites may determine that it is beneficial to co-optimize all or part of their EV charging load with their other facility load and DERs. For example, certain sites may keep some EVSEs, such as DCFC equipments, in a same optimization framework as other facility load and/or DERs.

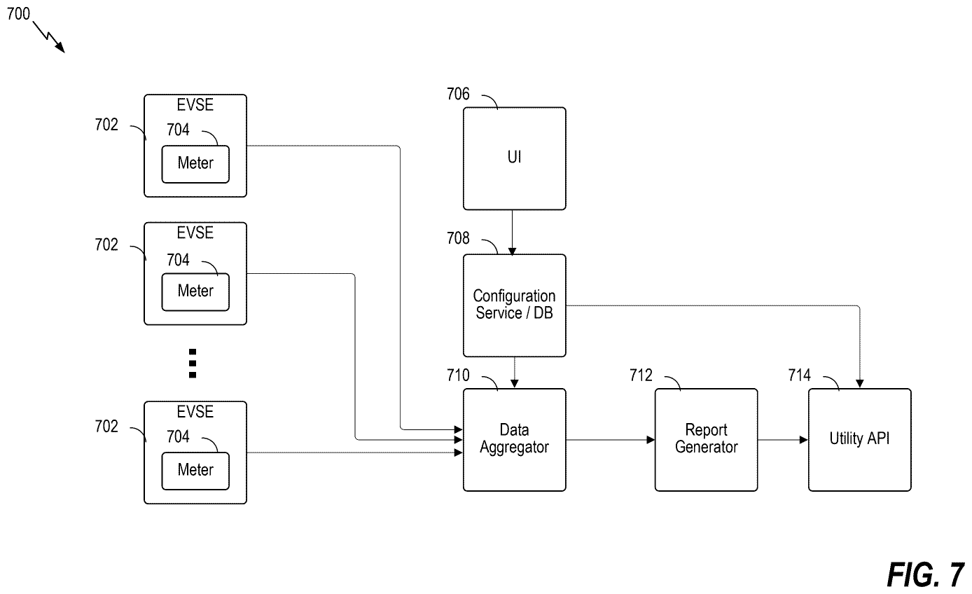

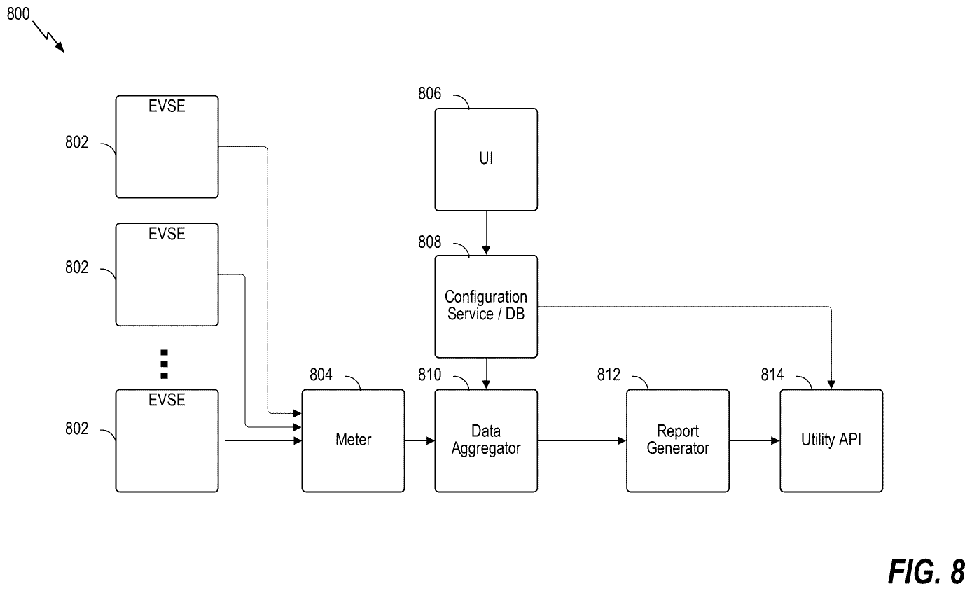

Certain aspects may provide a tool to help customers determine if submetering is a practical solution for them and what tariff to use. This offers significant advantages over certain existing methods of managing EVSEs. Not only are there benefits and advantages in capital cost to customer, capital cost to ratepayer, operational cost to customer, and/or convenience of paying for electricity, but certain aspects of the present disclosure provide technical benefits and advantages in responsiveness to changing grid signals (e.g., relating to pricing or tariff) and billing flexibility and scalability. Certain aspects provide a submetering system (e.g., including an MDMA platform) which is capable of meeting certain utility requirements. Some aspects may provide an interface (e.g., a user interface, such as described with respect to FIG. 7 or FIG. 8) for sites to select tariffs based on different groupings of EVSEs and/or building load. Certain aspects may use meter data to determine the aggregate benefits for customers, ratepayers, and/or drivers of widespread availability of virtual submetering for EVSEs.

In certain aspects, components of an aggregated virtual submetering system described herein may include one or more EVSEs (e.g., with onboard meters), communications link between EVSEs and other components of the system described herein (e.g., for communicating wirelessly via wireless technologies using Zigbee, Wi-Fi, Ethernet, cellular network, etc.). Moreover, certain components of the aggregated virtual submetering system (e.g., including a control and monitoring system), such as virtual submetering system 236 of FIG. 2 and/or virtual submetering system 540 of FIG. 5, may perform or provide data gathering, data aggregation, utility interface, user interface, load management, tariff management, and/or demand response signal processing. Additionally, some aspects may include or use utility submetering components and/or utility billing components, for example, as part of one or more components described herein with reference to FIG. 2 and/or FIG. 5.

An example of the user interface, such as described with respect to FIG. 7 or FIG. 8, may provide an interface that enables (1) creating one or more groups or subsets of EVSEs (e.g., including selecting one or more EVSEs, creating a group based on the selected EVSEs, and assigning the group to a (e.g., existing) submeter or creating a new submeter to which the group may be assigned); (2) editing one or more groups or subsets of EVSEs (e.g., including selecting a (e.g., existing) group to edit, selecting one or more EVSEs that are not part of the group to join the group, moving an EVSE to the group if the EVSE is already assigned to another group (e.g., where no EVSE may be in multiple groups), selecting EVSE(s) currently assigned to the group to be removed, and/or selecting EVSE(s) to move to another group (e.g., in which case the EVSE(s) may be removed from the group and added or re-assigned to the other group)); (3) creating a submeter (e.g., a virtual submeter—also referred to herein as a submeter grouping) (e.g., including requesting a new submeter, establishing a new submeter account (with a utility system) that is made available and accessible via the aggregated virtual submetering system described herein, and selecting one or more (e.g., existing) groups to be under that submeter or creating a new group to select for the submeter); (4) editing a submeter (e.g., including selecting a (e.g., existing) submeter and adding/removing/moving groups assigned to that submeter, such as where each group may belong (e.g., only) to one submeter at a time); and/or (5) removing a submeter (e.g., making a request to remove a submeter (e.g., including removing the submeter or marking it as inactive, or similar, with a utility system)).

Certain aspects may also include a data collection functionality. For example, data may be collected from EVSEs (such as described with respect to FIG. 6A or FIG. 6B), and virtual meter data may be calculated. For example, data may be collected from EVSEs periodically (e.g., every minute). The collected data may include one or more of total cumulative energy delivered, session energy delivered, instantaneous power draw, instantaneous current draw, instantaneous voltage, etc. The collected data (e.g., which may be referred to as interval data) may be stored in a data repository, such as via a database (e.g., database 228 of FIG. 2 or database 532 of FIG. 5). At the end of a billing period, certain aspects may use the groupings (e.g., submeter groupings) and/or group/subset-to-submeter mappings to calculate aggregate meter values for all EVSEs assigned to a given submeter. Certain validation checks may be run against these aggregations to ensure accuracy. For example, certain aspects may include a validation logic or circuitry (e.g., a validation component) that is configured to parse the collected data (e.g., meter data) to determine whether there is any missing data (e.g., a missing timestamp or similar in a sequence of time series data) or any unrealistic data or outliers (e.g., based on certain standard deviation thresholds, etc.). In some aspects, the validation component may be configured to determine whether a sum of the loads of a plurality of submeter groupings may exceed a total load associated with the plurality of submeter groupings (e.g., a load of a site, etc.). When the sum of the loads is different than the total load, the validation component may determine that there is missing or incorrect data. As part of the validation, any missing data may be recovered from, for example, a meter, and any “offending” data (e.g., unrealistic data or outlier(s)) may be removed, for obtaining or determining validated data (e.g., validated meter data), before the validated meter data is subsequently formatted and transmitted to a service provider such as the utility. These aggregate meter values for each submeter may be formatted into a defined format (e.g., as requested by the utility), and the formatted aggregate meter values may be sent to the utility (or any service provider such as an accounting or billing service provider, which may use the received data to calculate bills for each account, etc.). For example, the utility may apply a separate cost or tariff for the submeter and/or the EVSEs assigned to the submeter.

Certain aspects may include an optimization functionality (e.g., with submeters). For each group of chargers, some aspects may create a component of an objective function for an optimization problem which is used to determine the cost for the chargers in that group. This cost may include the cost of electricity (e.g., energy, demand charges, etc.), incentives (e.g., low carbon fuel credits), delay costs, etc. The full objective function of the problem may include some common components for (e.g., all) EVSEs at a site as well as a sum of the objective component(s) for respective group(s) of EVSEs. Constraints of a scheduling problem may include limits on the total power draw of the site and/or limits on the local infrastructure of the site. This scheduling problem may be solved, in some cases using convex or non-convex optimization methods, to arrive at a charging profile for each EVSE at the site. This charging profile determined for each EVSE may be sent to that EVSE, where the charging profile (e.g., including an optimized set-point) may be implemented to control the charging rate of the attached electric vehicle.

Certain aspects may provide a multi-objective optimization framework for managing charging operations across multiple submeter groupings (e.g., for a site or a plurality of EVSEs that span multiple sites, etc.). In some aspects, different submeter groupings may be configured to optimize for different, and potentially conflicting, objectives while sharing common infrastructure and constraints. Certain aspects may leverage the flexibility of virtual submetering, such as described herein, to enable independent optimization strategies for different groups of EVSEs while maintaining coordination through shared site-level objectives and constraints. For example, these aspects may determine set-points for different groups of EVSEs, where a first subset of set-points for a first subset of EVSEs and a second subset of set-points for a second subset of EVSEs may be in accordance with different and independent optimization strategies that are subject to shared site-level objectives and/or constraints. These aspects may control an energy flow (e.g., cause certain amounts of energy to flow) to the EVSEs based on the determined set-points (e.g., optimized set-points).

In certain aspects, a site may include a first submeter grouping (e.g., Group A) and a second submeter grouping (e.g., Group B), where each grouping is associated with a distinct optimization objective. For example, the first submeter grouping may be configured to optimize for a first objective such as minimizing energy costs according to time-of-use (TOU) rates and/or participating in demand response programs. The second submeter grouping may be configured to optimize for a second objective such as maximizing charging speed to ensure rapid vehicle turnaround, or responding to a different tariff structure such as a dynamic tariff that changes on a regular basis (e.g., an hourly basis). These different objectives may be in conflict with one another in certain scenarios. For instance, minimizing cost may include charging during off-peak hours at lower power levels, while maximizing charging speed may include immediate high-power charging regardless of time-of-use pricing.

While the submeter groupings may have independent objectives, they may be coupled through one or more shared site-level objectives and constraints. In some aspects, a third objective (e.g., Objective C) may represent a coupling or regularization term that coordinates the behavior across multiple submeter groupings. Examples of such coupling objectives may include, but are not limited to: a regularization term to smooth overall site load profiles, prioritization rules (such as prioritizing the first X kilowatt-hours across all groups), soft capacity limitations to avoid infrastructure stress, or other site-level optimization goals. These coupling objectives may ensure that while individual submeter groupings may be associated with their respective goals (e.g., optimization goals), the overall site operation may remain coordinated and efficient.

In certain aspects, multiple submeter groupings may share common infrastructure constraints that are respected during optimization. These infrastructure constraints may include, but are not limited to: transformer capacity limits that restrict the total power draw across all EVSEs at the site, electrical panel or circuit breaker limits that restrict power flow through specific electrical distribution points, utility service interconnection limits that define the maximum power that can be drawn from (or supplied to) the utility grid, and local electrical infrastructure capacity limitations, etc. In some aspects, these constraints may be implemented as hard constraints that must not be violated under any circumstances. In other aspects, certain constraints may be implemented as soft constraints that are incorporated into the shared site objective (e.g., Objective C) with associated penalty terms, allowing limited constraint violations when the benefit to other objectives outweighs the penalty.

Some aspects may provide a centralized optimization algorithm that (e.g., simultaneously) is used for determining charging rates across (e.g., all) submeter groupings while balancing the individual objectives of each grouping and the shared site objectives. In certain aspects, the overall optimization problem may be formulated such that the total objective function is a weighted sum of the individual submeter grouping objectives and the shared site objective(s). For example, the total objective may be expressed as: Total Objective=w_a*Objective_A+w_b*Objective_B+w_c*Objective_C, where Objective_A is the objective function which depends only on the charging rates of stations in Group A, Objective_B is the objective function which depends only on the charging rates of stations in Group B, and Objective_C is the objective function that may depend on the charging rates of any charging station. w_a, w_b, and w_c are weighting coefficients that determine the relative priority of each objective. In some aspects, these weights may be configured by a site administrator, determined automatically based on tariff structures and site priorities, or adjusted dynamically based on current system conditions.

In certain aspects, the centralized optimization algorithm may be implemented using model predictive control (MPC). The MPC approach solves an optimization problem over a future time horizon (e.g., the next 1 hour, 4 hours, or 24 hours, etc.) to determine optimal charging rates for each EVSE, taking into account predicted future conditions such as anticipated vehicle arrivals and departures, forecasted energy prices, expected demand response events, and/or predicted solar generation or building load profiles, etc. The optimization may be triggered periodically (e.g., every 5 minutes, every 15 minutes, etc.) and/or in response to specific events such as a new vehicle connection, a vehicle disconnection, a change in energy prices, the start or end of a demand response event, or a modification to submeter grouping configurations.

When the objectives of different submeter groupings conflict, certain aspects resolve these conflicts through the weighted objective function framework. For example, if minimizing Objective_A and Objective_B independently would violate a shared constraint, the optimization algorithm determines a solution that balances both objectives according to their respective weights while respecting all infrastructure constraints. With respect to the example described above, the solution may allocate more power to Group B for rapid charging while reducing power to Group A and/or scheduling Group A's charging during off-peak periods, such that the weighted combination of both objectives is optimized.

A technical benefit of certain aspects may be that the virtual submetering described herein enables decoupled control or management of EVSEs (e.g., setting set-points based on cost and/or billing decoupling between different groups of EVSEs, which in turn enables optimization flexibility that would not be practical with conventional shared metering). Specifically, because each submeter grouping can be associated with its own utility tariff and receive its own utility bill based on its aggregated meter data, each submeter grouping may be associated with (e.g., apply) one or more optimization strategies that are tailored to its specific tariff structure and/or operational requirements without affecting the energy costs of other groupings. For example, Group A on a TOU tariff can optimize its charging schedule to minimize costs under that tariff structure, while Group B on a dynamic hourly tariff can respond to hourly price signals, even though both groups share the same physical electrical infrastructure.

Certain aspects provide the flexibility to independently control charging rates for different submeter groupings (each optimizing for its own objectives and/or responding to its own price signals) while simultaneously respecting shared infrastructure constraints and/or optimizing for shared site-level objectives. This capability is enabled by the centralized optimization algorithm that has visibility into all submeter groupings and their associated objectives, tariffs, and/or constraints. These aspects may provide a technical solution to the technology of controlling energy flow for a charging site including multiple EVSEs, where certain existing systems may: (1) operate all EVSEs under a single tariff and optimization strategy, being incapable of tailoring strategies to different user needs and tariff structures, or (2) physically separate the electrical infrastructure for different groups, which would eliminate the ability to share infrastructure capacity and would significantly increase installation costs and reduce flexibility.

While certain examples described above may describe two submeter groupings (Group A and Group B) for clarity of illustration, it should be understood that certain aspects may support an arbitrary number of submeter groupings (e.g., Group A, Group B, Group C, . . . , Group N) consistent with the present disclosure. Each submeter grouping may have its own distinct objective, its own tariff structure, and/or its own operational requirements. The centralized optimization algorithm scales to accommodate multiple groupings by formulating the total objective as a sum of all individual grouping objectives plus the shared site objective(s): Total Objective=Σ(w_i×Objective_i)+w_site×Objective_site, where the sum is taken over all submeter groupings i, w_i are the respective weights, and Objective_site represents the shared site-level objective(s).

As an example, a constrained optimization formulation for allocating electrical capacity across two submeter groupings with heterogeneous objectives, such as fast charging (for Group A) and cost minimization (for Group B), may be as follows. The two groups (e.g., two submeter groupings) may share common infrastructure and may be scheduled jointly. The objective function for Group A may reward early energy delivery via decreasing weights, the objective function for Group B may penalize charging during high-price periods, and the objective function for non-completion penalty may penalize unmet energy demands with quadratic cost. These objective functions may be expressed as Equations (1), (2), and (3), as follows.

$${U}_{A} ( r ) = {\sum }_{i ∈ {V}_{A}} {\sum }_{t = 1}^{T} \frac{T - ( t - 1 )}{T} \cdot {r}_{i} ( t ) \qquad ( 1 )$$

$${U}_{B} ( r ) = - {\sum }_{i ∈ {V}_{A}} {\sum }_{t = 1}^{T} K ( t ) \cdot {r}_{i} ( t ) \qquad ( 2 )$$

$${U}_{NC} ( r ) = - γ {\sum }_{i ∈ V} {( max ( 0 , {e}_{i} - {\sum }_{t = 1}^{T} {r}_{i} ( t ) ) )}^{2} \qquad ( 3 )$$

V_{A}, V_{B} may correspond to sets of EVSEs in Groups A and B. T={1, . . . , T} may correspond to time periods in planning horizon. rᵢ(t)≥0 may correspond to charging rate for EVSE i at time t (in Amp-intervals). ŕᵢ may correspond to maximum charging rate for EVSE i. eᵢ may correspond to energy demand for EV i (in same units as cumulative rᵢ(t)). dᵢ may correspond to departure time for EV i. κ(t) may correspond to time-of-use electricity price at time t. w(t)=(T−t+1)/T may correspond to time-decreasing weight for fast charging. y may correspond to non-completion penalty weight. Ar_{l,i} may correspond to constraint matrix mapping EVSE i to infrastructure limit l. Cₗ may correspond to capacity limit for infrastructure constraint l. All quantities are expressed in consistent units where the sum of charging rates rat over time directly compares to energy demands eᵢ. For example, if rᵢ(t) represents charging in Amp-intervals, then eᵢ represents total demand in the same Amp-interval units, eliminating the need for explicit voltage and duration conversion factors.

The complete optimization problem for the example described above may be expressed as follows, where α_{A}, α_{B}, α_{NC}>0 are objective weights balancing fast charging priority, cost sensitivity, and demand fulfillment.

$${max}_{r} {α}_{A} {\sum }_{i ∈ {V}_{A}} {\sum }_{t = 1}^{T} \frac{T - ( t - 1 )}{T} \cdot {r}_{i} ( t ) - {α}_{B} {\sum }_{i ∈ {V}_{A}} {\sum }_{t = 1}^{T} K ( t ) \cdot {r}_{i} ( t ) - {α}_{NC} \cdot γ {\sum }_{i ∈ V} {( max ( 0 , {e}_{i} - {\sum }_{t = 1}^{T} {r}_{i} ( t ) ) )}^{2} \qquad ( 4 )$$

$$s . t .$$

$$\begin{matrix}0 \leq {r}_{i} ( t ) \leq {{r}^{′}}_{i} & ∀ i , t\end{matrix} \qquad ( rate bounds )$$

$$\begin{matrix}{r}_{i} ( t ) = 0 & ∀ t > {d}_{i}\end{matrix} \qquad ( departure )$$

$$\begin{matrix}{\sum }_{t = 1}^{T} {r}_{i} ( t ) \leq {e}_{i} & ∀ i\end{matrix} \qquad ( energy limit )$$

$$\begin{matrix}\vert {\sum }_{i} {A}_{1 , i} \cdot {r}_{i} ( t ) \vert \leq {c}_{1} & ∀ t\end{matrix} \qquad ( transformer )$$

The characteristics of the complete optimization problem above may be: (1) the type may be Second-Order Cone Program (SOCP) due to three-phase transformer constraint; (2) the variables may include |V|×T continuous decision variables; (3) the coupling may include infrastructure constraints couple both groups, requiring joint optimization; and (4) the solution may requires numerical methods, where no closed-form solution may exist. The computational nature of this optimization—requiring iterative methods to navigate a high-dimensional solution space subject to coupled non-linear constraints—establishes that the aggregated virtual submetering systems and methods amount to a technological improvement to electrical infrastructure management. The aggregated virtual submetering systems and methods described herein may solve this optimization problem (e.g., such as via one or more components at the edge (e.g., edge environment 102), such as optimization and control manager 203 and/or virtual submetering system 236 of FIG. 2, and/or one or more components in the cloud (e.g., cloud environment 104), such as optimization and control API 525 and/or virtual submetering system 540 of FIG. 5, including one or more components of the example 700 of internal submetering system or the example 800 of external submetering system) repeatedly and quickly to adapt to changes like new vehicle arrivals or departures, which cannot be performed in the human mind.

Certain aspects may include an access control functionality based on groups. In some aspects, the groups described above may also serve to determine access control groups. In this case, (e.g., only) users with correct permissions (e.g., login credentials) or devices (e.g., RFID card, NFC device, key, etc.) may use the chargers that belong to a certain group (e.g., assigned to a submeter). The party paying for the electricity used by the EVSE(s) included in a group (or assigned to a submeter) may then be limited in terms of who can control the management of the EVSE(s). In certain cases, the utility may have requirements for a specific tariff, such as where a tariff may (e.g., only) be applicable for public charging or for fleet charging, etc.

FIGS. 6A and 6B depict example process flows 600, 610 for managing a plurality of EVSEs, via a virtual submetering system such as virtual submetering system 236 of FIG. 2 and/or virtual submetering system 540 of FIG. 5 (e.g., having one or more components described with respect to FIG. 7 or FIG. 8), according to aspects provided herein. In certain aspects, the example process flow 610 of FIG. 6B may enable identifying or generating session data associated with a virtual submeter, such as to enable a more granular metering, management, or optimization scheme for EVSE(s) associated with the virtual submeter, such as when compared to the example process flow 600 of FIG. 6A. For example, the session data may be associated with one or more users (or user groupings, etc.), such that the management (e.g., applying different tariffs, etc.) and/or optimization may be performed in accordance with not only the different groups of EVSEs but also the different groups of users, etc.

The example process flow 600 of FIG. 6A starts with collecting data from EVSEs at 602. In certain aspects, the virtual submetering system may include a data collector in data communication with the EVSEs (e.g., with onboard meters of the EVSEs), which is configured to collect data (e.g., meter data) from the EVSEs. In some cases, the collected data may be stored in a data storage (e.g., via a database such as database 228 of FIG. 2 or database 532 of FIG. 5).

At 604, the collected data may be aggregated by group. In certain aspects, a data aggregator (e.g., data aggregator 710 of FIG. 7 or data aggregator 810 of FIG. 8) may aggregate the collected data from 602 by group. For example, portions of the collected data that are associated with one or more EVSEs of a defined group or subset of EVSEs may be aggregated in a data structure and associated with the group or subset of EVSEs.

At 606, the groups may be aggregated into virtual submeters. In certain aspects, the data aggregator may aggregate the portions of the collected data from 602 by virtual submeter. For example, one or more groups or subsets of EVSEs may be associated with a virtual submeter (a submeter grouping), and the portions of the collected data that are collected from these groups or subsets of EVSEs may be aggregated and associated with the virtual submeter, such as for segregated management.

At 608, a report may be generated for each virtual submeter. In certain aspects, a report generator (e.g., report generator 712 of FIG. 7 or report generator 812 of FIG. 8) may generate a report for each virtual submeter. For example, the report generator may format the aggregated data in a defined format that is compatible with processing by a utility.

The example process flow 610 of FIG. 6B starts with collecting data from EVSEs at 612. In certain aspects, the virtual submetering system may include a data collector in data communication with the EVSEs (e.g., with onboard meters of the EVSEs), which is configured to collect data (e.g., meter data) from the EVSEs. In some cases, the collected data may be stored in a data storage (e.g., via a database such as database 228 of FIG. 2 or database 532 of FIG. 5).

At 614, the collected data may be split by session (e.g., into, or to generate, session data). In certain aspects, the data aggregator, such as described with respect to the step 604 of FIG. 6A, may identify or generate session data that includes the collected data as split by session.

At 616, the session data may be aggregated by user (e.g., into, or to generate, user data). In certain aspects, the data aggregator may aggregate portions of the collected data (e.g., the collected session data) together, where the aggregated portions may correspond to portions that are associated with a particular user. For example, the data aggregator may generate user data that includes session data associated with the particular user.

At 618, the user data may be aggregated by group. In certain aspects, the data aggregator may aggregate the user data from 618 by group. For example, portions of the user data that are associated with one or more EVSEs of a defined group or subset of EVSEs may be aggregated in a data structure and associated with the group or subset of EVSEs.

At 620, the groups may be aggregated into virtual submeters. In certain aspects, the data aggregator may aggregate the portions of the user data from 618 by virtual submeter. For example, one or more groups or subsets of EVSEs may be associated with a virtual submeter (a submeter grouping), and the portions of the user data that are collected from these groups or subsets of EVSEs may be aggregated and associated with the virtual submeter, such as for segregated management.

At 622, a report may be generated for each virtual submeter. In certain aspects, a report generator (e.g., report generator 712 of FIG. 7 or report generator 812 of FIG. 8) may generate a report for each virtual submeter. For example, the report generator may format the aggregated data from 620 in a defined format that is compatible with processing by a utility.

FIG. 7 depicts an example 700 of an internal submetering system for managing a plurality of EVSEs, according to aspects provided herein. The components of the example 700 of a virtual submetering system (e.g., with onboard EVSE metering) include EVSEs 702 with onboard meters 704 (e.g., embedded meters, such as embedded submeters within EVSEs 702), a user interface (UI) 706, a configuration service 708 (e.g., including a database), a data aggregator 710, a report generator 712, and a utility API 714.

As depicted, each EVSE 702 has an (e.g., internal) onboard meter 704 which collects data (such as described with respect to 602 of FIG. 6A or 612 of FIG. 6B). This data is communicated through the EVSE 702 to a data aggregator 710 (e.g., as collected by a data collector, such as described with respect to 602 of FIG. 6A or 612 of FIG. 6B) via a communications protocol (e.g., Wi-Fi, Cellular, Ethernet, Zigbee, or other communications protocol). The data aggregator 710 may be or include a logical service which may be located on the edge (e.g., edge environment 102), in the cloud (e.g., cloud environment 104), or split between the two.

Users may be able to interact with the configuration of the service via a user interface (e.g., the UI 706). The configuration of virtual submetering may be input and stored by the configuration service 708. The configuration may be updated via a UI, API, or other interface. The configuration service 708 may also communicate directly with the utility API 714 in order to configure and register submeters. In certain aspects, as described above, the UI 706 may enable: (1) creating one or more groups or subsets of EVSEs (e.g., including selecting one or more EVSEs, creating a group based on the selected EVSEs, and assigning the group to a (e.g., existing) submeter or creating a new submeter to which the group may be assigned); (2) editing one or more groups or subsets of EVSEs (e.g., including selecting a (e.g., existing) group to edit, selecting one or more EVSEs that are not part of the group to join the group, moving an EVSE to the group if the EVSE is already assigned to another group (e.g., where no EVSE may be in multiple groups), selecting EVSE(s) currently assigned to the group to be removed, and/or selecting EVSE(s) to move to another group (e.g., in which case the EVSE(s) may be removed from the group and added or re-assigned to the other group)); (3) creating a submeter (e.g., a virtual submeter—also referred to herein as a submeter grouping) (e.g., including requesting a new submeter, establishing a new submeter account (with a utility system) that is made available and accessible via the aggregated virtual submetering system described herein, and selecting one or more (e.g., existing) groups to be under that submeter or creating a new group to select for the submeter); (4) editing a submeter (e.g., including selecting a (e.g., existing) submeter and adding/removing/moving groups assigned to that submeter, such as where each group may belong (e.g., only) to one submeter at a time); and/or (5) removing a submeter (e.g., making a request to remove a submeter (e.g., including removing the submeter or marking it as inactive, or similar, with a utility system)).

The data aggregator 710 may provide a service responsible for collecting data from the EVSEs and aggregating them by group and/or by submeter (as well as by session and/or by user, such as described with respect to FIG. 6B). The configuration of groups and/or submeters may be obtained from the configuration service 708. The aggregated data may then be formatted into reports by the report generator 712. These reports may then be transmitted to the utility (e.g., for billing purposes), such as by using the utility API 714.

FIG. 8 depicts an example 800 of an external submetering system for managing a plurality of EVSEs, according to aspects provided herein. The components of the example 800 of a virtual submetering system (e.g., with external EVSE metering) include EVSEs 802 coupled to a meter 804 (e.g., an external meter, which may be connected to the EVSEs 802 and/or EV electrical outlet(s)), a UI 806 (similar to UI 706 of FIG. 7), a configuration service 808 (e.g., including a database) (similar to configuration service 708 of FIG. 7), a data aggregator 810 (similar to data aggregator 710 of FIG. 7), a report generator 812 (similar to report generator 712 of FIG. 7), and a utility API 814 (similar to utility API 714 of FIG. 7).

In the depicted example 800, internal metering of EVSE may not be used, and in some cases, the internal metering may be absent. As depicted, there may be an additional external meter (e.g., meter 804) which monitors the power draw, current draw, energy draw, and/or voltage of one or more EVSEs 802 and communicates this data to the data aggregator 810 (e.g., as collected by a data collector, such as described with respect to 602 of FIG. 6A or 612 of FIG. 6B). In some cases, there may be no direct communications link between the EVSEs 802 and the meter 804, where the meter 804 may gather data (e.g., directly) by monitoring the electrical lines leading to each EVSE 802. The data from the meter 804 may be communicated to the data aggregator 810 via a communications protocol (e.g., Wi-Fi, Cellular, Ethernet, Zigbee, or other communications protocol). The data aggregator 810 may be or include a logical service which may be located on the edge (e.g., edge environment 102), in the cloud (e.g., cloud environment 104), or split between the two.

As similarly described with respect to the UI 706 of FIG. 7, users may be able to interact with the configuration of the service via a user interface (e.g., the UI 806). The configuration of virtual submetering may be input and stored by the configuration service 808. The configuration may be updated via a UI, API, or other interface. The configuration service 808 may also communicate directly with the utility API 814 in order to configure and register submeters. In certain aspects, as described above, the UI 806 may enable: (1) creating one or more groups or subsets of EVSEs (e.g., including selecting one or more EVSEs, creating a group based on the selected EVSEs, and assigning the group to a (e.g., existing) submeter or creating a new submeter to which the group may be assigned); (2) editing one or more groups or subsets of EVSEs (e.g., including selecting a (e.g., existing) group to edit, selecting one or more EVSEs that are not part of the group to join the group, moving an EVSE to the group if the EVSE is already assigned to another group (e.g., where no EVSE may be in multiple groups), selecting EVSE(s) currently assigned to the group to be removed, and/or selecting EVSE(s) to move to another group (e.g., in which case the EVSE(s) may be removed from the group and added or re-assigned to the other group)); (3) creating a submeter (e.g., a virtual submeter—also referred to herein as a submeter grouping) (e.g., including requesting a new submeter, establishing a new submeter account (with a utility system) that is made available and accessible via the aggregated virtual submetering system described herein, and selecting one or more (e.g., existing) groups to be under that submeter or creating a new group to select for the submeter); (4) editing a submeter (e.g., including selecting a (e.g., existing) submeter and adding/removing/moving groups assigned to that submeter, such as where each group may belong (e.g., only) to one submeter at a time); and/or (5) removing a submeter (e.g., making a request to remove a submeter (e.g., including removing the submeter or marking it as inactive, or similar, with a utility system)).

The data aggregator 810 may provide a service responsible for collecting data from the EVSEs (e.g., through the meter 804) and aggregating them by group and/or by submeter (as well as by session and/or by user, such as described with respect to FIG. 6B). The configuration of groups and/or submeters may be obtained from the configuration service 808. The aggregated data may then be formatted into reports by the report generator 812. These reports may then be transmitted to the utility (e.g., for billing purposes), such as by using the utility API 814.

### Example Method of Managing a Plurality of EVSEs

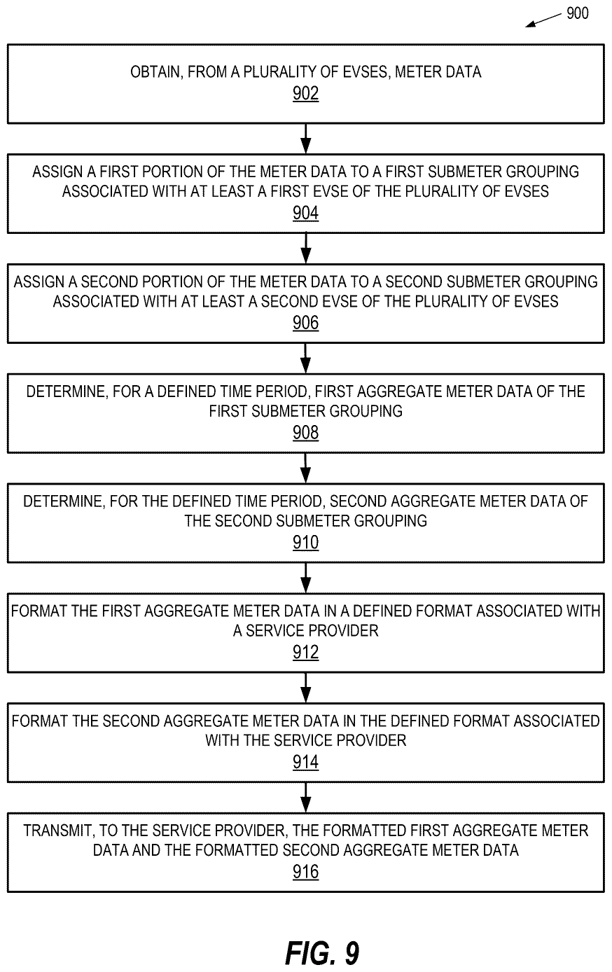

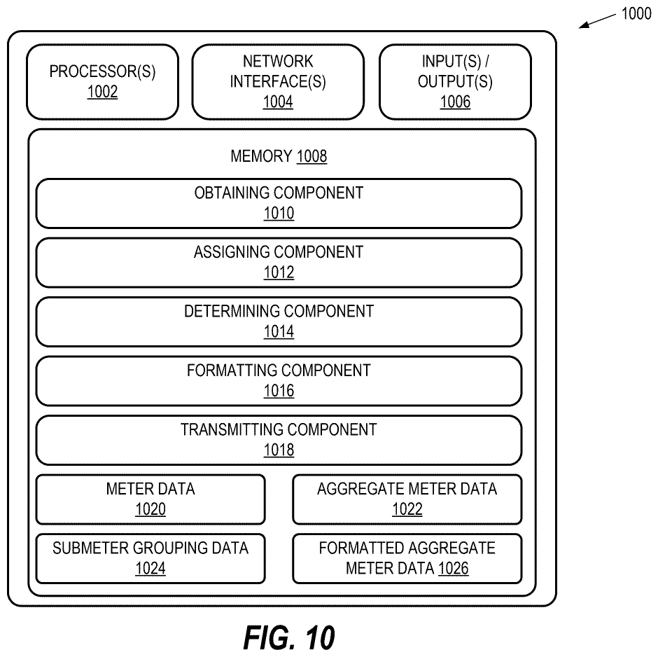

FIG. 9 depicts an example flowchart illustrating a method 900 for managing a plurality of EVSEs, according to aspects provided herein. The method 900 may be performed by a core device 302 of FIG. 3, for example, by utilizing one or more components of edge environment 102 described herein with respect to FIG. 2 and/or one or more components of cloud environment 104 described herein with respect to FIG. 5. In some aspects, the method 900 may be performed by one or more components of the example 700 of internal submetering system described herein with respect to FIG. 7 or one or more components of the example 800 of external submetering system described herein with respect to FIG. 8. In some aspects, the method 900 may be performed by an apparatus or a processing system, for example, by utilizing one or more components of processing system 1000 described herein with respect to FIG. 10.

Method 900 begins at block 902 with obtaining, from a plurality of EVSEs, meter data. In certain aspects, obtaining the meter data at block 902 may be an example of collecting meter data as described with respect to, for example, FIG. 6A, 6B, 7, or 8.

Method 900 then proceeds to block 904 with assigning a first portion of the meter data to a first submeter grouping associated with at least a first EVSE of the plurality of EVSEs. In certain aspects, assigning the first portion of the meter data to the first submeter grouping at block 904 may be an example of, or correspond to, aggregating the collected meter data by a virtual submeter, such as described with respect to, for example, FIG. 6A, 6B, 7, or 8.

Method 900 then proceeds to block 906 with assigning a second portion of the meter data to a second submeter grouping associated with at least a second EVSE of the plurality of EVSEs. In certain aspects, assigning the second portion of the meter data to the second submeter grouping at block 906 may be an example of, or correspond to, aggregating the collected meter data by a virtual submeter, such as described with respect to, for example, FIG. 6A, 6B, 7, or 8.

Method 900 then proceeds to block 908 with determining, for a defined time period, first aggregate meter data of the first submeter grouping. In certain aspects, determining the first aggregate meter data at block 908 may be an example of, or correspond to, aggregating the collected meter data by a virtual submeter, such as described with respect to, for example, FIG. 6A, 6B, 7, or 8.

Method 900 then proceeds to block 910 with determining, for the defined time period, second aggregate meter data of the second submeter grouping. In certain aspects, determining the second aggregate meter data at block 910 may be an example of, or correspond to, aggregating the collected meter data by a virtual submeter, such as described with respect to, for example, FIG. 6A, 6B, 7, or 8.

Method 900 then proceeds to block 912 with formatting the first aggregate meter data in a defined format associated with a service provider. In certain aspects, formatting the first aggregate meter data in the defined format associated with the service provider at block 912 may be an example of, or correspond to, generating a report for a virtual submeter, such as described with respect to, for example, FIG. 6A, 6B, 7, or 8.

Method 900 then proceeds to block 914 with formatting the second aggregate meter data in the defined format associated with the service provider. In certain aspects, formatting the second aggregate meter data in the defined format associated with the service provider at block 914 may be an example of, or correspond to, generating a report for a virtual submeter, such as described with respect to, for example, FIG. 6A, 6B, 7, or 8.

Method 900 then proceeds to block 916 with transmitting, to the service provider, the formatted first aggregate meter data and the formatted second aggregate meter data. In certain aspects, transmitting the formatted first aggregate meter data to the service provider and/or transmitting the formatted second aggregate meter data to the service provider at block 916 may be an example of, or correspond to, transmitting a generated report for a virtual submeter, such as described with respect to, for example, FIG. 6A, 6B, 7, or 8.

In certain aspects, the first submeter grouping and the second submeter grouping are associated with a site that is associated with the plurality of EVSEs.

In certain aspects, the first submeter grouping is associated with a first utility tariff, and the second submeter grouping is associated with a second utility tariff different than the first utility tariff.

In certain aspects, method 900 further includes: receiving, via a user interface, an input indicating an instruction to disassociate the first EVSE from the first submeter grouping and to associate the first EVSE with the second submeter grouping; determining, for another defined time period, third aggregate meter data of the first submeter grouping and fourth aggregate meter data of the second submeter grouping, the third aggregate meter data excluding meter data associated with the first EVSE, the fourth aggregate meter data comprising meter data associated with the first EVSE; formatting each of the third aggregate meter data and the fourth aggregate meter data in the defined format associated with the service provider; and transmitting, to the service provider, the formatted third aggregate meter data and the formatted fourth aggregate meter data.

In certain aspects, the first submeter grouping is associated with a first site that is associated with a first subset of the plurality of EVSEs, and the second submeter grouping is associated with a second site that is associated with a second subset of the plurality of EVSEs, the second site being different than the first site, the second subset being different than the first subset.

In certain aspects, obtaining the meter data comprises obtaining a plurality of corresponding portions of the meter data from a plurality of respective embedded meters of the plurality of EVSEs.

In certain aspects, obtaining the meter data comprises obtaining the meter data from one or more external meters in data communication with the plurality of EVSEs.

In certain aspects, method 900 further includes: receiving, via a user interface, an input indicating an instruction to disassociate the first EVSE from the first submeter grouping; determining, for another defined time period, third aggregate meter data of the first submeter grouping, the third aggregate meter data excluding meter data associated with the first EVSE; formatting the third aggregate meter data in the defined format associated with the service provider; and transmitting, to the service provider, the formatted third aggregate meter data.

In certain aspects, method 900 further includes: receiving, via a user interface, an input indicating an instruction to associate a third EVSE of the plurality of EVSEs with the first submeter grouping; determining, for another defined time period, third aggregate meter data of the first submeter grouping, the third aggregate meter data comprising meter data associated with the third EVSE; formatting the third aggregate meter data in the defined format associated with the service provider; and transmitting, to the service provider, the formatted third aggregate meter data.

In certain aspects, the first submeter grouping is associated a subset of the plurality of EVSEs, the subset comprising at least the first EVSE.

In certain aspects, method 900 further includes: determining an optimized set-point associated with the first EVSE based on one or more constraints associated with one or more of: a site comprising the plurality of EVSEs, or one or more subsets of the plurality of EVSEs, a subset of the one or more subsets comprising the first EVSE; and causing an energy transfer to the first EVSE at a charging rate based on the optimized set-point. For example, method 900 may include determining an optimized set-point associated with the first EVSE by solving a multi-objective optimization problem, the multi-objective optimization problem comprising: a first objective associated with the first submeter grouping; a second objective associated with the second submeter grouping, wherein the second objective is different than the first objective; a coupling objective associated with the plurality of EVSEs (e.g., at a site); and one or more constraints that apply to a combination of the first submeter grouping and the second submeter grouping; and causing an energy transfer to the first EVSE at a charging rate based on the optimized set-point (e.g., using a controller, one or more contactors or relays, and/or one or more power distribution units).

In certain aspects, method 900 further includes: determining that a user is authenticated for modifying the first submeter grouping; receiving, via a user interface and based on the user being authenticated, an input from the user, the input indicating an instruction to modify the first submeter grouping; and modifying the first submeter grouping based on the input.

In certain aspects, modifying the first submeter grouping comprises associating a third EVSE of the plurality of EVSEs with the first submeter grouping or disassociating the third EVSE from the first submeter grouping.

In some aspects, method 900 may allow arbitrary grouping and re-grouping of EVSEs, which enable a site to adapt to changing conditions, such as changing tariffs and/or usage patterns. Accordingly, method 900 may enable an aggregated virtual submetering system (such as described herein) to overcome the impracticalities described herein. As an example, a site may initially have its EVSEs split into (e.g., assigned to) two submetering groups for two existing groups (e.g., tenants). Then, one or more EVSEs of the two submetering groups may be split into (e.g., re-assigned to) a new submetering group (e.g., a third virtual submeter for a particular tenant), such as at a later time. Certain aspects of method 900 may provide the site host (or certain users) sufficient permissions to self-service the grouping and/or re-grouping of EVSEs and assignment of groups of EVSEs to virtual submeters. Some aspects may allow for submetering to work seamlessly with adaptive load management to allow a site to stay below local and/or grid-level constraints (e.g., simultaneously) while also enabling the submetering schemes described herein. Certain aspects may enable each submetering group to adaptively respond to changing price signals, which may also be compatible with the adaptive load management, such that a site may enforce hard infrastructure limits while simultaneously making it practical to respond to various changing price signals (e.g., without incurring added cost or delay in deployment).

In some aspects, the method 900 may be performed by an apparatus or a processing system, for example, by utilizing one or more components of processing system 1000 described herein with respect to FIG. 10. Processing system 1000 is described below in further detail.

Note that FIG. 9 is just one example of a method, and other methods including fewer, additional, or alternative operations are possible consistent with this disclosure.

### Example Processing System for Managing a Plurality of EVSEs

FIG. 10 depicts an example processing system 1000 configured to perform the methods described herein.

Processing system 1000 may include one or more processors 1002. Generally, the one or more processors 1002 may be configured to execute computer-executable instructions (e.g., software code) to perform various functions, as described herein.

Processing system 1000 may further include one or more network interfaces 1004, which generally provide data access to any sort of data network, including personal area networks (PANs), local area networks (LANs), wide area networks (WANs), the internet, and the like.

Moreover, processing system 1000 may include input(s) and output(s) 1006, which generally provide means for providing data to and from processing system 1000, such as via connection to computing device peripherals, including user interface peripherals.

Processing system 1000 may also include one or more memories 1008 comprising various components. In this example, the one or more memories 1008 may include obtaining component 1010, assigning component 1012, determining component 1014, formatting component 1016, transmitting component 1018, meter data 1020, aggregate meter data 1022, submeter grouping data 1024, and formatted aggregate meter data 1026.

In certain aspects, obtaining component 1010 is configured to obtain, from the plurality of EVSEs, meter data (e.g., meter data 1020), as described in FIG. 9 with reference to block 902. In certain aspects, assigning component 1012 is configured to assign a first portion of the meter data to a first submeter grouping (e.g., of submeter grouping data 1024) associated with at least a first EVSE of the plurality of EVSEs and to assign a second portion of the meter data to a second submeter grouping (e.g., of submeter grouping data 1024) associated with at least a second EVSE of the plurality of EVSEs, as described in FIG. 9 with reference to block 904 and block 906, respectively. In certain aspects, determining component 1014 is configured to determine, for a defined time period, first aggregate meter data (e.g., aggregate meter data 1022) of the first submeter grouping and to determine, for the defined time period, second aggregate meter data (e.g., aggregate meter data 1022) of the second submeter grouping, as depicted in FIG. 9 with reference to block 908 and block 910, respectively. In certain aspects, formatting component 1016 is configured to format the first aggregate meter data in a defined format associated with a service provider and to format the second aggregate meter data in the defined format associated with the service provider, as depicted in FIG. 9 with reference to block 912 and block 914, respectively. In certain aspects, transmitting component 1018 is configured to transmit, to the service provider, the formatted first aggregate meter data and the formatted second aggregate meter data (e.g., formatted aggregate meter data 1026), as depicted in FIG. 9 with reference to block 916.

Processing system 1000 may be implemented in various ways. For example, processing system 1000 may be implemented as a computing device 402 within a core device 302, described herein with respect to FIGS. 3A-C and 4A-C. In various aspects, one or more aspects may be omitted from, added to, or substituted from processing system 1000.

### Example Clauses

Implementation examples are described in the following numbered clauses:

Clause 1: A method for managing a plurality of EVSEs, the method comprising: obtaining, from the plurality of EVSEs, meter data; assigning a first portion of the meter data to a first submeter grouping associated with at least a first EVSE of the plurality of EVSEs; assigning a second portion of the meter data to a second submeter grouping associated with at least a second EVSE of the plurality of EVSEs; determining, for a defined time period, first aggregate meter data of the first submeter grouping; determining, for the defined time period, second aggregate meter data of the second submeter grouping; formatting the first aggregate meter data in a defined format associated with a service provider; formatting the second aggregate meter data in the defined format associated with the service provider; and transmitting, to the service provider, the formatted first aggregate meter data and the formatted second aggregate meter data.

Clause 2: The method in accordance with Clause 1, wherein the first submeter grouping and the second submeter grouping are associated with a site that is associated with the plurality of EVSEs.

Clause 3: The method in accordance with Clause 2, wherein: the first submeter grouping is associated with a first utility tariff, and the second submeter grouping is associated with a second utility tariff different than the first utility tariff.

Clause 4: The method in accordance with Clause 2, further comprising: receiving, via a user interface, an input indicating an instruction to disassociate the first EVSE from the first submeter grouping and to associate the first EVSE with the second submeter grouping; determining, for another defined time period, third aggregate meter data of the first submeter grouping and fourth aggregate meter data of the second submeter grouping, the third aggregate meter data excluding meter data associated with the first EVSE, the fourth aggregate meter data comprising meter data associated with the first EVSE; formatting each of the third aggregate meter data and the fourth aggregate meter data in the defined format associated with the service provider; and transmitting, to the service provider, the formatted third aggregate meter data and the formatted fourth aggregate meter data.

Clause 5: The method in accordance with any one of Clauses 1-4, wherein: the first submeter grouping is associated with a first site that is associated with a first subset of the plurality of EVSEs, and the second submeter grouping is associated with a second site that is associated with a second subset of the plurality of EVSEs, the second site being different than the first site, the second subset being different than the first subset.

Clause 6: The method in accordance with any one of Clauses 1-5, wherein obtaining the meter data comprises obtaining a plurality of corresponding portions of the meter data from a plurality of respective embedded meters of the plurality of EVSEs.

Clause 7: The method in accordance with any one of Clauses 1-6, wherein obtaining the meter data comprises obtaining the meter data from one or more external meters in data communication with the plurality of EVSEs.

Clause 8: The method in accordance with any one of Clauses 1-7, further comprising: receiving, via a user interface, an input indicating an instruction to disassociate the first EVSE from the first submeter grouping; determining, for another defined time period, third aggregate meter data of the first submeter grouping, the third aggregate meter data excluding meter data associated with the first EVSE; formatting the third aggregate meter data in the defined format associated with the service provider; and transmitting, to the service provider, the formatted third aggregate meter data.

Clause 9: The method in accordance with any one of Clauses 1-8, further comprising: receiving, via a user interface, an input indicating an instruction to associate a third EVSE of the plurality of EVSEs with the first submeter grouping; determining, for another defined time period, third aggregate meter data of the first submeter grouping, the third aggregate meter data comprising meter data associated with the third EVSE; formatting the third aggregate meter data in the defined format associated with the service provider; and transmitting, to the service provider, the formatted third aggregate meter data.

Clause 10: The method in accordance with any one of Clauses 1-9, wherein the first submeter grouping is associated a subset of the plurality of EVSEs, the subset comprising at least the first EVSE.

Clause 11: The method in accordance with any one of Clauses 1-10, further comprising: determining an optimized set-point associated with the first EVSE based on one or more constraints associated with one or more of: a site comprising the plurality of EVSEs, or one or more subsets of the plurality of EVSEs, a subset of the one or more subsets comprising the first EVSE; and causing an energy transfer to the first EVSE at a charging rate based on the optimized set-point.

Clause 12: The method in accordance with any one of Clauses 1-11, further comprising: determining that a user is authenticated for modifying the first submeter grouping; receiving, via a user interface and based on the user being authenticated, an input from the user, the input indicating an instruction to modify the first submeter grouping; and modifying the first submeter grouping based on the input.

Clause 13: The method in accordance with Clause 12, wherein modifying the first submeter grouping comprises associating a third EVSE of the plurality of EVSEs with the first submeter grouping or disassociating the third EVSE from the first submeter grouping.

Clause 14: One or more apparatuses, comprising means for performing a method in accordance with any one of Clauses 1-13.

Clause 15: A processing system, comprising means for performing a method in accordance with any one of Clauses 1-13.

Clause 16: A processing system, comprising: one or more memories comprising computer-executable instructions; and one or more processors configured to execute the computer-executable instructions and cause the processing system to perform a method in accordance with any one of Clauses 1-13.

Clause 17: A non-transitory computer-readable medium comprising computer-executable instructions that, when executed by a processor of a processing system, cause the processing system to perform a method in accordance with any one of Clauses 1-13.

Clause 18: A computer program product embodied on a computer-readable storage medium comprising code for performing a method in accordance with any one of Clauses 1-13.

Clause 19: A processing system, comprising: one or more memories; and one or more processors, coupled to the one or more memories, configured to cause the processing system to perform a method in accordance with any one of Clauses 1-13.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) (logic) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a memory,” “the processor,” “the memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., a system) to perform functions, one element may be configured to cause the other element to perform all functions, or more than one element may collectively be configured to cause the other element to perform the functions. Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

While particular aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the aspects shown and described herein.

What is claimed is:

1. A method for managing a plurality of electric vehicle supply equipments (EVSEs), comprising:
obtaining, from the plurality of EVSEs, meter data;
assigning a first portion of the meter data to a first submeter grouping associated with at least a first EVSE of the plurality of EVSEs;
assigning a second portion of the meter data to a second submeter grouping associated with at least a second EVSE of the plurality of EVSEs;
determining, for a defined time period, first aggregate meter data of the first submeter grouping;
determining, for the defined time period, second aggregate meter data of the second submeter grouping;
formatting the first aggregate meter data in a defined format associated with a service provider;
formatting the second aggregate meter data in the defined format associated with the service provider; and
transmitting, to the service provider, the formatted first aggregate meter data and the formatted second aggregate meter data.

2. The method of claim 1, wherein the first submeter grouping and the second submeter grouping are associated with a site that is associated with the plurality of EVSEs.

3. The method of claim 2, wherein:
the first submeter grouping is associated with a first utility tariff, and
the second submeter grouping is associated with a second utility tariff different than the first utility tariff.

4. The method of claim 2, further comprising:
receiving, via a user interface, an input indicating an instruction to disassociate the first EVSE from the first submeter grouping and to associate the first EVSE with the second submeter grouping;
determining, for another defined time period, third aggregate meter data of the first submeter grouping and fourth aggregate meter data of the second submeter grouping, the third aggregate meter data excluding meter data associated with the first EVSE, the fourth aggregate meter data comprising meter data associated with the first EVSE;
formatting each of the third aggregate meter data and the fourth aggregate meter data in the defined format associated with the service provider; and
transmitting, to the service provider, the formatted third aggregate meter data and the formatted fourth aggregate meter data.

5. The method of claim 1, wherein:
the first submeter grouping is associated with a first site that is associated with a first subset of the plurality of EVSEs, and
the second submeter grouping is associated with a second site that is associated with a second subset of the plurality of EVSEs, the second site being different than the first site, the second subset being different than the first subset.

6. The method of claim 1, wherein obtaining the meter data comprises obtaining a plurality of corresponding portions of the meter data from a plurality of respective embedded meters of the plurality of EVSEs.

7. The method of claim 1, wherein obtaining the meter data comprises obtaining the meter data from one or more external meters in data communication with the plurality of EVSEs.

8. The method of claim 1, further comprising:
receiving, via a user interface, an input indicating an instruction to disassociate the first EVSE from the first submeter grouping;
determining, for another defined time period, third aggregate meter data of the first submeter grouping, the third aggregate meter data excluding meter data associated with the first EVSE;
formatting the third aggregate meter data in the defined format associated with the service provider; and
transmitting, to the service provider, the formatted third aggregate meter data.

9. The method of claim 1, further comprising:
receiving, via a user interface, an input indicating an instruction to associate a third EVSE of the plurality of EVSEs with the first submeter grouping;
determining, for another defined time period, third aggregate meter data of the first submeter grouping, the third aggregate meter data comprising meter data associated with the third EVSE;
formatting the third aggregate meter data in the defined format associated with the service provider; and
transmitting, to the service provider, the formatted third aggregate meter data.

10. The method of claim 1, wherein the first submeter grouping is associated a subset of the plurality of EVSEs, the subset comprising at least the first EVSE.

11. The method of claim 1, further comprising:
determining an optimized set-point associated with the first EVSE based on one or more constraints associated with one or more of:
a site comprising the plurality of EVSEs, or
one or more subsets of the plurality of EVSEs, a subset of the one or more subsets comprising the first EVSE; and
causing an energy transfer to the first EVSE at a charging rate based on the optimized set-point.

12. The method of claim 1, further comprising:
determining that a user is authenticated for modifying the first submeter grouping;
receiving, via a user interface and based on the user being authenticated, an input from the user, the input indicating an instruction to modify the first submeter grouping; and
modifying the first submeter grouping based on the input.

13. The method of claim 12, wherein modifying the first submeter grouping comprises associating a third EVSE of the plurality of EVSEs with the first submeter grouping or disassociating the third EVSE from the first submeter grouping.

14. A processing system, comprising: one or more memories comprising computer-executable instructions; and one or more processors configured to execute the computer-executable instructions and cause the processing system to:
obtain, from a plurality of electric vehicle supply equipments (EVSEs), meter data;
assign a first portion of the meter data to a first submeter grouping associated with at least a first EVSE of the plurality of EVSEs;
assign a second portion of the meter data to a second submeter grouping associated with at least a second EVSE of the plurality of EVSEs;
determine, for a defined time period, first aggregate meter data of the first submeter grouping;
determine, for the defined time period, second aggregate meter data of the second submeter grouping;
format the first aggregate meter data in a defined format associated with a service provider;
format the second aggregate meter data in the defined format associated with the service provider; and
transmit, to the service provider, the formatted first aggregate meter data and the formatted second aggregate meter data.

15. The processing system of claim 14, wherein the first submeter grouping and the second submeter grouping are associated with a site that is associated with the plurality of EVSEs.

16. The processing system of claim 15, wherein:
the first submeter grouping is associated with a first utility tariff, and
the second submeter grouping is associated with a second utility tariff different than the first utility tariff.

17. The processing system of claim 15, wherein the one or more processors are further configured to cause the processing system to:
receive, via a user interface, an input indicating an instruction to disassociate the first EVSE from the first submeter grouping and to associate the first EVSE with the second submeter grouping;
determine, for another defined time period, third aggregate meter data of the first submeter grouping and fourth aggregate meter data of the second submeter grouping, the third aggregate meter data excluding meter data associated with the first EVSE, the fourth aggregate meter data comprising meter data associated with the first EVSE;
format each of the third aggregate meter data and the fourth aggregate meter data in the defined format associated with the service provider; and
transmit, to the service provider, the formatted third aggregate meter data and the formatted fourth aggregate meter data.

18. The processing system of claim 14, wherein:
the first submeter grouping is associated with a first site that is associated with a first subset of the plurality of EVSEs, and
the second submeter grouping is associated with a second site that is associated with a second subset of the plurality of EVSEs, the second site being different than the first site, the second subset being different than the first subset.

19. The processing system of claim 14, wherein to cause the processing system to obtain the meter data, the one or more processors are configured to cause the processing system to obtain a plurality of corresponding portions of the meter data from a plurality of respective embedded meters of the plurality of EVSEs.

20. The processing system of claim 14, wherein to cause the processing system to obtain the meter data, the one or more processors are configured to cause the processing system to obtain the meter data from one or more external meters in data communication with the plurality of EVSEs.
